(19) United States
(12) Patent Application Publication
(10) Pub. No.: US 2025/0330271 A1
(43) Pub. Date: Oct. 23, 2025

(54) RATE MATCHING AND SIGNALING IN PROBABILITY CONSTELLATION SHAPING IN WI-FI SYSTEMS

(71) Applicant: QUALCOMM Incorporated, San Diego, CA (US)

(72) Inventors: Jialing Li CHEN, San Diego, CA (US); Eugene BAIK, Sunnyvale, CA (US); Bin TIAN, San Diego, CA (US)

(21) Appl. No.: 19/186,273

(22) Filed: Apr. 22, 2025

Related U.S. Application Data
(60) Provisional application No. 63/637,880, filed on Apr. 23, 2024.

(51) Int. Cl. H04L 1/00; H04W 28/04; H04W 84/12

(52) U.S. Cl. CPC H04L 1/0068; H04W 28/04; H04W 84/12

(57) ABSTRACT

This disclosure provides methods, components, devices and systems for rate matching and signaling in probability constellation shaping in Wi-Fi systems. Some aspects more specifically relate to a rate matching algorithm and various rules, calculations, procedures, and signaling designs to support rate matching in conjunction with probability constellation shaping. In some examples, a wireless communication device functioning as a transmitter device may implement a rate matching algorithm to determine a pre-forward error correction (FEC) padding boundary, a pre-FEC padding size, a quantity of codewords, and a post-FEC padding size given a presumed payload size after shaping, a codeword size, and an effective code rate. Additionally, or alternatively, a wireless communication device may indicate information associated with an application of a constellation shaping. Such information may indicate a specific constellation shaping combination or whether constellation shaping is set to an ON or OFF sets, or both.

### CROSS REFERENCES

The present application for patent claims benefit of U.S. Provisional Patent Application No. 63/637,880 by CHEN et al., entitled “RATE MATCHING AND SIGNALING IN PROBABILITY CONSTELLATION SHAPING IN WI-FI SYSTEMS,” filed Apr. 23, 2024, assigned to the assignee hereof, and expressly incorporated herein.

### TECHNICAL FIELD

This disclosure relates generally to wireless communication and, more specifically, to rate matching and signaling in probability constellation shaping in Wi-Fi systems.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

In some wireless communication networks, one or more wireless communication devices may employ probability constellation shaping. In accordance with probability constellation shaping, constellation points of a constellation may be associated with variable usage frequencies such that, for example, constellation points closer to an origin may be associated with a higher usage frequency than those located further from the origin. In some scenarios, probability constellation shaping may change a physical layer (PHY) payload size. A payload size after shaping may be a function of a payload size before shaping and a shaping rate.

### SUMMARY

The systems, methods, and devices of this disclosure each have several innovative aspects, no single one of which is solely responsible for the desirable attributes disclosed herein.

One innovative aspect of the subject matter described in this disclosure can be implemented in an apparatus for wireless communication at a wireless communication device. The apparatus may include a processing system that includes processor circuitry and memory circuitry that stores code. The processing system may be configured to cause the apparatus to obtain information indicative of a first data size associated with a set of multiple information bits, obtain a set of multiple shaped information bits in association with applying a constellation shaping to the set of multiple information bits, the set of multiple shaped information bits associated with a second data size different than the first data size, generate one or more codewords in association with performing an error correction encoding associated with the set of multiple shaped information bits and a first set of multiple padding bits, a quantity of the first set of multiple padding bits associated with at least a codeword size, a quantity of the one or more codewords, and the second data size, and transmit a packet including the one or more codewords in association with generating the one or more codewords.

Another innovative aspect of the subject matter described in this disclosure can be implemented in a method for wireless communication at a wireless communication device. The method may include obtaining information indicative of a first data size associated with a set of multiple information bits, obtaining a set of multiple shaped information bits in association with applying a constellation shaping to the set of multiple information bits, the set of multiple shaped information bits associated with a second data size different than the first data size, generating one or more codewords in association with performing an error correction encoding associated with the set of multiple shaped information bits and a first set of multiple padding bits, a quantity of the first set of multiple padding bits associated with at least a codeword size, a quantity of the one or more codewords, and the second data size, and transmitting a packet including the one or more codewords in association with generating the one or more codewords.

Another innovative aspect of the subject matter described in this disclosure can be implemented in an apparatus for wireless communication at a wireless communication device. The apparatus may include means for obtaining information indicative of a first data size associated with a set of multiple information bits, means for obtaining a set of multiple shaped information bits in association with applying a constellation shaping to the set of multiple information bits, the set of multiple shaped information bits associated with a second data size different than the first data size, means for generating one or more codewords in association with performing an error correction encoding associated with the set of multiple shaped information bits and a first set of multiple padding bits, a quantity of the first set of multiple padding bits associated with at least a codeword size, a quantity of the one or more codewords, and the second data size, and means for transmitting a packet including the one or more codewords in association with generating the one or more codewords.

Another innovative aspect of the subject matter described in this disclosure can be implemented in a non-transitory computer-readable medium storing code for wireless communication at an apparatus (such as at a wireless communication device). The code may include instructions executable by one or more processors to cause the apparatus (or the wireless communication device) to obtain information indicative of a first data size associated with a set of multiple information bits, obtain a set of multiple shaped information bits in association with applying a constellation shaping to the set of multiple information bits, the set of multiple shaped information bits associated with a second data size different than the first data size, generate one or more codewords in association with performing an error correction encoding associated with the set of multiple shaped information bits and a first set of multiple padding bits, a quantity of the first set of multiple padding bits associated with at least a codeword size, a quantity of the one or more codewords, and the second data size, and transmit a packet including the one or more codewords in association with generating the one or more codewords.

In some examples of the method, apparatuses, wireless communication devices, and non-transitory computer-readable medium described herein, the quantity of the first set of multiple padding bits may be at least associated with a difference between a first value and a second value, the first value may be equal to a product of the quantity of the one or more codewords, the codeword size, and an effective code rate associated with the one or more codewords, and the second value may be equal to the first data size.

In some examples of the method, apparatuses, wireless communication devices, and non-transitory computer-readable medium described herein, the codeword size may be associated with one or more of a fixed amount of shortening bits per codeword, a fixed amount of puncturing bits per codeword, or a fixed amount of repeated bits per codeword in accordance with the constellation shaping being applied to the set of multiple information bits.

Another innovative aspect of the subject matter described in this disclosure can be implemented in an apparatus for wireless communication at a first wireless communication device. The apparatus may include a processing system that includes processor circuitry and memory circuitry that stores code. The processing system may be configured to cause the apparatus to transmit a frame that includes information associated with an application of a constellation shaping to communication between the first wireless communication device and at least a second wireless communication device and communicate one or more packets with at least the second wireless communication device in accordance with the information associated with the application of the constellation shaping.

Another innovative aspect of the subject matter described in this disclosure can be implemented in a method for wireless communication at a first wireless communication device. The method may include transmitting a frame that includes information associated with an application of a constellation shaping to communication between the first wireless communication device and at least a second wireless communication device and communicating one or more packets with at least the second wireless communication device in accordance with the information associated with the application of the constellation shaping.

Another innovative aspect of the subject matter described in this disclosure can be implemented in an apparatus for wireless communication at a first wireless communication device. The apparatus may include means for transmitting a frame that includes information associated with an application of a constellation shaping to communication between the first wireless communication device and at least a second wireless communication device and means for communicating one or more packets with at least the second wireless communication device in accordance with the information associated with the application of the constellation shaping.

Another innovative aspect of the subject matter described in this disclosure can be implemented in a non-transitory computer-readable medium storing code for wireless communication at an apparatus (such as at a first wireless communication device). The code may include instructions executable by one or more processors to cause the apparatus (or the first wireless communication device) to transmit a frame that includes information associated with an application of a constellation shaping to communication between the first wireless communication device and at least a second wireless communication device and communicate one or more packets with at least the second wireless communication device in accordance with the information associated with the application of the constellation shaping.

In some examples of the method, first wireless communication devices, and non-transitory computer-readable medium described herein, transmitting the frame that includes the information associated with the application of the constellation shaping may include operations, features, means, or instructions for transmitting, via a subfield of a user info field associated with the second wireless communication device, an indication of a constellation shaping combination, from a set of multiple constellation shaping combinations, associated with the communication between the first wireless communication device and the second wireless communication device.

In some examples of the method, first wireless communication devices, and non-transitory computer-readable medium described herein, transmitting the frame that includes the information associated with the application of the constellation shaping may include operations, features, means, or instructions for transmitting an indication that the application of the constellation shaping may be associated with an ON state or an OFF state.

Another innovative aspect of the subject matter described in this disclosure can be implemented in an apparatus for wireless communication at a first wireless communication device. The apparatus may include a processing system that includes processor circuitry and memory circuitry that stores code. The processing system may be configured to cause the apparatus to receive a frame that includes information associated with an application of a constellation shaping to communication between the first wireless communication device and at least a second wireless communication device and communicate one or more packets with at least the second wireless communication device in accordance with the information associated with the application of the constellation shaping.

Another innovative aspect of the subject matter described in this disclosure can be implemented in a method for wireless communication at a first wireless communication device. The method may include receiving a frame that includes information associated with an application of a constellation shaping to communication between the first wireless communication device and at least a second wireless communication device and communicating one or more packets with at least the second wireless communication device in accordance with the information associated with the application of the constellation shaping.

Another innovative aspect of the subject matter described in this disclosure can be implemented in an apparatus for wireless communication at a first wireless communication device. The apparatus may include means for receiving a frame that includes information associated with an application of a constellation shaping to communication between the first wireless communication device and at least a second wireless communication device and means for communicating one or more packets with at least the second wireless communication device in accordance with the information associated with the application of the constellation shaping.

Another innovative aspect of the subject matter described in this disclosure can be implemented in a non-transitory computer-readable medium storing code for wireless communication at an apparatus (such as at a first wireless communication device). The code may include instructions executable by one or more processors to cause the apparatus (or the first wireless communication device) to receive a frame that includes information associated with an application of a constellation shaping to communication between the first wireless communication device and at least a second wireless communication device and communicate one or more packets with at least the second wireless communication device in accordance with the information associated with the application of the constellation shaping.

In some examples of the method, apparatuses, first wireless communication devices, and non-transitory computer-readable medium described herein, receiving the frame that includes the information associated with the application of the constellation shaping may include operations, features, means, or instructions for receiving, via a subfield of a user info field associated with the first wireless communication device, an indication of a constellation shaping combination, from a set of multiple constellation shaping combinations, associated with the communication between the first wireless communication device and the second wireless communication device.

In some examples of the method, apparatuses, first wireless communication devices, and non-transitory computer-readable medium described herein, receiving the frame that includes the information associated with the application of the constellation shaping may include operations, features, means, or instructions for receiving an indication that the application of the constellation shaping may be associated with an ON state or an OFF state.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network that illustrates various wireless communication devices capable of over-the-air signaling.

FIG. 2 shows an example transmission diagram associated with an application of a probability constellation shaping to an information bitstream.

FIG. 3 shows an example modulation scheme that illustrates a mapping of systematic bits and parity bits to modulation symbols in accordance with an application of a probability constellation shaping to an information bitstream.

FIG. 4 shows example low-density parity check (LDPC) codewords that illustrate various codeword sizes depending on a presence of one or more shortening bits, one or more puncturing bits, one or more repeated bits, or any combination thereof.

FIGS. 5 and 6 show example rate matching schemes that support rate matching in combination with probability constellation shaping.

FIGS. 7 and 8 show example rate matching algorithms that support rate matching in combination with probability constellation shaping and that are implementable at one or both of a transmitter device or a receiver device.

FIG. 9 shows an example signaling diagram that illustrates how various wireless communication devices may provide information associated with an application of a probability constellation shaping.

FIG. 10 shows an example user info field format that a wireless communication device may use to signal information associated with an application of a probability constellation shaping.

FIG. 11 shows a block diagram of an example wireless communication device that supports rate matching and signaling in probability constellation shaping in Wi-Fi systems.

FIG. 12 shows a flowchart illustrating an example process performable by or at a wireless communication device that supports a rate matching algorithm associated with facilitating compatibility between LDPC rate matching and probability constellation shaping.

FIGS. 13 and 14 show flowcharts illustrating example processes performable by or at a first wireless communication device that supports a signaling of information associated with an application of a probability constellation shaping.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (M USA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (W PAN), a wireless local area network (WLAN), a wireless wide area network (WWAN), a wireless metropolitan area network (WMAN), a non-terrestrial network (NTN), or an internet of things (IoT) network.

In some wireless communication networks, a wireless communication device, such as an access point (AP) or a station (STA), may communicate (such as transmit or receive, or both) in accordance with a coding scheme (such as an encoding or decoding scheme). In some cases, a wireless communication device may use an error correcting code, such as a low-density parity check (LDPC) code. In accordance with an LDPC code, a wireless communication device may generate or obtain one or more LDPC codewords, which may be or refer to a set or sequence of bits. For example, an LDPC codeword may correspond to a data message (such as a message of one or more bits). Generally, an LDPC codeword may correspond to an x-bit message encoded as y-bits (with redundancy sometimes used to increase a likelihood of successful communication between two wireless communication devices). In other words, an LDPC codeword (equivalently referred to herein as a “codeword”) may include one or more data bits and one or more parity bits. In some aspects, a quantity of the data bits and a quantity of the parity bits in a given LDPC codeword may impact other communication schemes that a wireless communication device may attempt to use.

In some scenarios, for example, a wireless communication device may perform rate matching on one or more LDPC codewords to fit the LDPC codewords within a boundary (such as within a physical layer coded bits boundary) of a packet. Rate matching may include puncturing, repeating, or shortening, which may change one or both of a quantity of data bits or a quantity of parity bits within each codeword. In accordance with a change to one or both of a quantity of data bits or a quantity of parity bits within each codeword, an effective code rate also may change. In other words, an effective code rate may be set (such as changed or determined) by way of performing LDPC rate matching processing.

Such an effective code rate set via LDPC rate matching processing, however, may adversely affect or lack compatibility with other wireless communication schemes, such as probability constellation shaping. For example, in probability constellation shaping, data bits may correspond to an amplitude in a quadrature amplitude modulation (QAM) mapping and parity bits may correspond to a sign in the QAM mapping. Accordingly, a wireless communication device may attempt to maintain a specific ratio between amplitude bits and sign bits (to match to a corresponding QAM or pattern of QAM s), but that ratio may be disrupted by the LDPC rate matching processing (in accordance with a change to one or both of the quantity of data bits or the quantity of parity bits). Therefore, some systems may benefit from changes in the LDPC rate matching process to use fixed quantities of shortening bits, punctured bits, or repeated bits to achieve a target effective code rate, so as to achieve a specific ratio between amplitude bits and sign bits (to match to a corresponding QAM or pattern of QAM s). Further, in probability constellation shaping, a payload size may change after shaping, which may impact a pre-forward error correction (FEC) padding boundary and a physical layer (PHY) coded bits boundary in the rate matching. In some systems, however, the wireless communication device may be expected to signal the common pre-FEC padding factor in a preamble before a data field is processed, such that the wireless communication device may have yet to calculate a payload size after constellation shaping.

Various aspects of the present disclosure relate generally to one or more configuration- or signaling-based mechanisms to support rate matching in probability constellation shaping in various systems, including Wi-Fi systems. Some aspects more specifically relate to a rate matching algorithm and various rules, calculations, procedures, and signaling designs to support rate matching in conjunction with probability constellation shaping. In some examples, a wireless communication device functioning as a transmitter device may implement a rate matching algorithm to determine (such as obtain, select, calculate, compute, or otherwise ascertain) a pre-FEC padding boundary, a pre-FEC padding size, a quantity of codewords, and a post-FEC padding size given a presumed (such as estimated) payload size after shaping, a (constellation shaped) codeword size, and an effective code rate. Additionally, a wireless communication device functioning as a receiver device may implement a rate matching algorithm to determine a quantity of codewords and a post-FEC padding size given the (constellation shaped) codeword size, the effective code rate, and the pre-FEC padding boundary. Additionally, or alternatively, various wireless communication devices may support a signaling mechanism according to which a wireless communication device may indicate information associated with an application of a constellation shaping. Such information may indicate a specific constellation shaping combination or whether constellation shaping is set to an ON state or an OFF state, or both.

Particular aspects of the subject matter described in this disclosure can be implemented to realize one or more of the following potential advantages. In some examples, by supporting mechanisms to provide a compatibility between LDPC rate matching and probability constellation shaping, the described techniques can be used to facilitate or achieve higher data rates, greater signal quality, and extended range. For example, a wireless communication device may achieve higher data rates in accordance with employing rate matching and may realize greater signal quality and extended range in accordance with leveraging LDPC codes (an error correcting code), extension of which to scenarios associated with probability constellation shaping may compound to additionally enable signals to attain a threshold entropy, or ability to carry information, while remaining within a threshold average power consumption at the transmitter device. In accordance with facilitating or achieving higher data rates, greater signal quality, and extended range, the example algorithms, rules, procedures, and signaling mechanisms disclosed herein may be further implemented to realize greater system capacity, greater spectral efficiency, longer battery life, or more efficient processing, among other benefits.

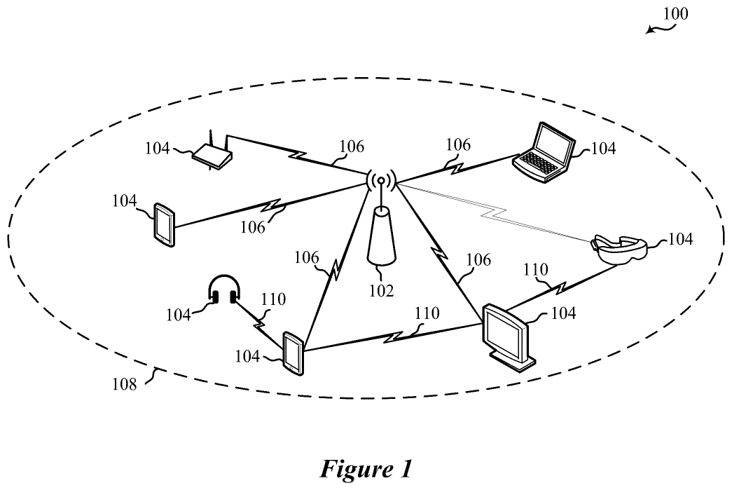

FIG. 1 shows a pictorial diagram of an example wireless communication network 100 that illustrates various wireless communication devices capable of over-the-air signaling. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless AP 102 and any number of wireless STAs 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency A P, a dual-band simultaneous (DBS) AP, a tri-band simultaneous (TBS) AP, a standalone A P, a non-standalone A P, a software-enabled A P (soft A P), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single A P 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the A P 102 to establish a respective communication link 106 (hereinafter also referred to as a “Wi-Fi link”), or to maintain a communication link 106, with the AP 102. For example, the beacons can include an identification or indication of a primary channel used by the respective A P 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHZ, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected A P 102. The selected A P 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one A P 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another A P 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the A P 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the A P 102 or the STAs 104, or both, may support applications associated with high throughput or low-latency requirements, or may provide lossless audio to one or more other devices. For example, the A P 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the A P 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHz, 6 GHZ, 45 GHZ, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHZ-52.6 GHz), FR3 (7.125 GHz-24.25 GHZ), FR4a or FR 4-1 (52.6 GHZ-71 GHz), FR4 (52.6 GHz-114.25 GHz), and FR5 (114.25 GHZ-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the A P 102 may select sixteen 20 MHz channels that collectively span an operating bandwidth of 320 MHz. Within the operating bandwidth, the A P 102 may typically select a single primary 20 MHz channel on which the A P 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TX OP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

Transmitting and receiving devices A P 102 and STA 104 may support the use of various modulation and coding schemes (MCSs) to transmit and receive data in the wireless communication network 100 so as to optimally take advantage of wireless channel conditions, for example, to increase throughput, reduce latency, or enforce various quality of service (QOS) parameters. For example, existing technology (such as IEEE 802.11ax standard amendment protocols) supports the use of up to 1024-QAM, where a modulated symbol carries 10 bits. To further improve peak data rate, each of the A P 102 or the STA 104 may employ use of 4096-QAM (also referred to as “4 k QAM”), which enables a modulated symbol to carry 12 bits. 4 k QAM may enable massive peak throughput with a maximum theoretical PHY rate of 10 bps/Hz/subcarrier/spatial stream, which translates to 23 Gbps with 5/6 low-density parity check (LDPC) code (10 bps/Hz/subcarrier/spatial stream*996*4 subcarriers*8 spatial streams/13.6 us per OFDM symbol). The AP 102 or the STA 104 using 4096-QAM may enable a 20% increase in data rate compared to 1024-QAM given the same coding rate, thereby allowing users to obtain higher transmission efficiency.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (such as APs 102 and STAs 104) and to enhance various aspects associated with wireless communication. For example, an AI/ML model may be trained to identify patterns or relationships in data observed in a wireless communication network 100. An AI/ML model may support operational decisions relating to aspects associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

An example AI/ML model may include mathematical representations or define computing capabilities for making inferences from input data based on patterns or relationships identified in the input data. As used herein, the term “inferences” can include one or more of decisions, predictions, determinations, or values, which may represent outputs of the AI/ML model. The computing capabilities may be defined in terms of certain parameters of the AI/ML model, such as weights and biases. Weights may indicate relationships between certain input data and certain outputs of the A I/ML model, and biases are offsets that may indicate a starting point for outputs of the A I/ML model. An example AI/ML model operating on input data may start at an initial output based on the biases and then update the output based on a combination of the input data and the weights.

STAs or APs (such as a STA 104 or an AP 102) may exchange local observations with other wireless communication devices (such as other STAs or APs) or provide feedback related to the communication. This may significantly expand the types of input data that can be considered as input to an AI/ML model, as such information may not otherwise be available at the other wireless communication devices. For example, information received from other STAs or APs may include observed RSSI values, experienced packet success/failure/retry rates per client/AP, BSS/Quality of Service (QOS) load/requirements, or a history of bad/good AP link(s), which may be conveyed in terms of scores or rankings.

AI/ML models can be centralized, distributed, or federated. As both STAs 104 and APs 102 can participate in A I/ML based operations, efficient AI/ML model distribution may enhance the performance of a wireless communication system. In some examples supporting centralized AI/ML models, STAs 104 may provide training data to a centralized network location (such as an AP, AP MLD, or a server) where a global AI/ML model may be generated and refined. The centralized network location may distribute the global AI/ML model to various STAs. In some examples, global AI/ML models may train a single classifier based on all training data received from various inputs/sources. In some examples supporting distributed learning or distributed models, both APs and STAs may be independently capable of computing AI/ML models and sharing data with other participating wireless communication devices in the wireless communication network such that each device can train the global AI/ML model locally. In some examples supporting a federated learning or hybrid AI/ML model, substantially all participating wireless communication devices (such as APs 102 and STAs 104) may be capable of generating local AI/ML models and sharing their local models to a centralized network location or entity. In turn, the centralized network entity may generate a global AI/ML model using the received local models as input and distribute the global model to all or a subset of the participating wireless communication devices.

In some examples, AI/ML models may be downloadable. For example, an AP may share AI/ML model components with associated STAs or other friendly/coordinating APs. STAs may download the AI/ML model and use the model for making decisions related to wireless communications. The downloading of an AI/ML model may be independent from signaling the inputs to the AI/ML model (such as some wireless communication devices may download the AI/ML model without exchanging information with other wireless communication devices; some wireless communication devices may exchange information and use such information as an input to the AI/ML model without downloading it; and some wireless communication devices may download the AI/ML model and exchange information or the AI/ML model with other wireless communication devices).

In some wireless communication systems, a wireless communication device may employ a rate matching technique, such as LDPC rate matching. As part of LDPC rate matching, which may involve an encoding process that applies to both SU transmission and a transmission of an MU PPDU to multiple users, a wireless communication device may perform a series of steps according to which the wireless communication device may determine, calculate, select, identify, ascertain, or otherwise obtain one or more parameters. The wireless communication device may use the one or more parameters to encode and transmit a packet or to receive and decode a received packet. A wireless communication device may refer to an AP 102 or a STA 104.

In a first step of LDPC rate matching, the wireless communication device may determine an LDPC pre-FEC padding boundary. In an (EHT) MU PPDU transmission, the wireless communication device may initially compute a quantity of data bits in a last OFDM symbol for user u in accordance with:

$${N}_{Excess , u} = ( 8 \cdot A P E {P}_{{LENGTH}_{u}} + {N}_{tail , u} + {N}_{service} ) mod {N}_{D B P S , u}$$

In some aspects, A PEP_LENGTHᵤ may be the TXVECTOR parameter APEP_LENGTH for the u-th user, N_{tail,u} may be the quantity of tails bits per encoder for user u, and N_{tail,u}=6 for binary convolutional coding (BCC) and N_{tail,u}=0 for LDPC, N_{service}=16 may be the quantity of bits in the SERVICE field, and N_{DBPS,u}=floor (N_{CBPS,u}·Rᵤ) may be the quantity of data bits per OFDM symbol for the u-th user, where Rᵤ may be the nominal coding rate for the u-th user; N_{CBPS,u}=N_{SD,u}·N_{ss,u}·N_{BPSCS,u} may be the threshold quantity of coded bits per OFDM symbol for user u, in which N_{SD,u} may be the N_{SD} (effective number of data tones carrying unique data in one OFDM symbol) value corresponding to the occupied RU or MRU size of the u-th user, N_{ss,u} may be the number of spatial streams for the u-th user, and N_{BPSCS,u} may be the threshold quantity of coded bits per OFDM symbol per spatial stream for user u.

In accordance with N_{Excess,u}, the wireless communication device (as a transmitter) may compute the initial quantity of symbol segments in the initial last OFDM symbol, such as the initial pre-FEC padding factor value a_{init,u} and the initial quantity of OFDM symbols, N_{SYM,init,u}, for user u using the following equations.

$${a}_{init , u} = \{ \begin{matrix}4 , & if {N}_{Excess , u} = 0 \\ min ( ⌈ \frac{{N}_{Excess , u}}{{N}_{D B P S , short , u}} ⌉ , 4 ) , & otherwise\end{matrix}$$

$${N}_{S Y M , init , u} = ⌈ \frac{8 \cdot A P E {P}_{{LENGTH}_{u}} + {N}_{tail , u} + {N}_{service}}{{N}_{D B P S , u}} ⌉$$

In some aspects, N_{DBPS,short,u}=N_{CBPS,short,u}·Rᵤ. Further, N_{CBPS,short,u}=N_{SD,short,u}·N_{ss,u}·N_{BPSCS,u}, in which N_{SD,short,u} may be the N_{SD,short} (effective quantity of data tones carrying unique data in each symbol segment of the first three symbol segments) value corresponding to the occupied RU or MRU size of the u-th user.

Among the users, the wireless communication device may derive the set of the user indices S, with the longest encoded packet duration as in the following equation, and may select one value from the set as uₘₐₓ.

$$S = arg {max}_{0 \leq u \leq {N}_{user , {total}^{- 1}}} ( {N}_{S Y M , init , u} - 1 + \frac{{a}_{init , u}}{4} )$$

In the context of the above equation:

$$arg max f ( x ) \text{:=} \{ x ∈ [ 0 , {N}_{user , total} - 1 ] : f ( y ) \leq f ( x ) for all y ∈ [ 0 , {N}_{user , total} - 1 ] \}$$

In some aspects, the wireless communication device may derive the common aᵢₙᵢₜ and N_{SYM,init} values among all the users using the following equations.

$${N}_{S Y M , init} = {{N}_{S Y M , init , u}}_{max}$$

$${a}_{init} = {{a}_{init , u}}_{max}$$

The wireless communication device may calculate each user's initial quantity of data bits N_{DBPS,last,init,u} and initial quantity of coded bits N_{CBPS,last,init,u} in its last OFDM symbol in accordance with the following equations, respectively.

$${N}_{D B P S , last , i n i t , u} = \{ \begin{matrix}{a}_{init} \cdot {N}_{D B P S , short , u} & if {a}_{init} < 4 \\ {N}_{D B P S , u} & if {a}_{init} = 4\end{matrix}$$

$${N}_{C B P S , last , init , u} = \{ \begin{matrix}{a}_{init} \cdot {N}_{C B P S , short , u} & if {a}_{init} < 4 \\ {N}_{C B P S , u} & if {a}_{init} = 4\end{matrix}$$

For each user with LDPC encoding, the wireless communication device may compute the parameters N_{pld,u} and N_{avbits,u} using the following equations, respectively.

$${N}_{pld , u} = ( {N}_{S Y M , init} - 1 ) {N}_{D B P S , u} + {N}_{D B P S , last , init , u}$$

$${N}_{avbits , u} = ( {N}_{S Y M , init} - 1 ) {N}_{C B P S , u} + {N}_{C B P S , last , init , u}$$

N_{pld,u} may be the PHY payload size, such as the quantity of data bits including pre-FEC padding bits, that fits in the PHY payload boundary (such as the pre-FEC padding boundary), which may be the end of the symbol segment aᵢₙᵢₜ in the OFDM symbol N_{SYM,init}. N_{avbits,u} may be the quantity of PHY coded bits that fits in the current PHY coded bits boundary, which may be the end of the symbol segment aᵢₙᵢₜ in the OFDM symbol N_{SYM,init}. Accordingly, the effective code rate associated with these two values may be calculated in accordance with:

$${eCR}_{u} = \frac{{N}_{pld , u}}{{N}_{avbits , u}} = \frac{( {N}_{S Y M , init} - 1 ) {N}_{D B P S , u} + {N}_{D B P S , last , init , u}}{( {N}_{S Y M , init} - 1 ) {N}_{C B P S , u} + {N}_{C B P S , last , init , u}} = {R}_{u}$$

Such an effective code rate may be the nominal code rate Ry of user u. In accordance with adjusting the PHY coded bits boundary by adding one or more OFDM symbols or fractions of symbol (such as one or more symbol segments) to accommodate more PHY coded bits, the wireless communication device may lower the effective code rate and reduce a puncturing ratio.

In a second step of LDPC rate matching, the wireless communication device may determine an LDPC codeword size and a quantity of codewords. In some aspects, the wireless communication device may compute an integer quantity of LDPC codewords to be transmitted for user u, N_{CW,u}, and the length of the codewords to be used for user u, L_{LDPC,u}, in accordance with Table 1, shown below.

TABLE 1
PPDU Encoding Parameters

| | Number of | |
|---|---|---|
| Range of | LDPC | |
| N_{avbits} | Codewords | LDPC Codeword |
| (bits) | (N_{CW}) | Length L_{LDPC} (bits) |
| N_{avbits} ≤ 648 | 1 | 1296, if N_{avbits} ≥ N_{pld} + |
| | | 912 × (1 − R); |
| | | 648 otherwise. |
| 648 < N_{avbits} ≤ 1296 | 1 | 1944, if N_{avbits} ≥ N_{pld} + |
| | | 1464 × (1 − R); |
| | | 1296 otherwise. |
| 1296 < N_{avbits} ≤ 1944 | 1 | 1944 |
| 1944 < N_{avbits} ≤ 2592 | 2 | 1944, if N_{avbits} ≥ N_{pld} + |
| | | 2916 × (1 − R); |
| | | 1296 otherwise. |
| 2592 < N_{avbits} | $⌈ \frac{{N}_{pld}}{1944 \cdot R} ⌉$ | 1944 |

In a third step of LDPC rate matching, the wireless communication device may compute a quantity of shortening bits for user u, N_{shrt,u}, to be padded to the N_{pld,u} data bits before encoding, in accordance with the following equation.

$${N}_{shrt , u} = max ( 0 , {N}_{C W , u} \cdot {L}_{L D P C , u} \cdot {R}_{u} - {N}_{pld , u} )$$

If N_{shrt,u}=0, shortening may not be performed. If N_{shrt,u}>0, shortening bits may be equally distributed over all N_{CW,u} codewords with the first rem(N_{shrt,u}, N_{CW,u}) codewords being shortened one bit more than the remaining codewords. Shortening bits may be appended after data bits. The shortening bits may be discarded after encoding.

In a fourth step of LDPC rate matching, the wireless communication device may compute a quantity of bits to be punctured for user u, N_{punc,u}, from the codewords after encoding, as follows.

$${N}_{punc , u} = max ( 0 , {N}_{C W , u} \cdot {L}_{L D P C , u} - {N}_{avbits , u} - {N}_{shrt , u} )$$

If N_{punc,u}=0, puncturing may not be performed. If N_{punc,u}>0, puncturing bits may be equally distributed over all N_{CW,u} codewords with the first rem(N_{punc,u}, N_{CW,u}) codewords being punctured one bit more than the remaining codewords. In some aspects, parity bits may be punctured while systematic bits may not be punctured.

If there is at least one user with LDPC encoding for which the following condition in LDPC encoding process is met:

$$( {N}_{punc , u} > 0.1 \cdot {N}_{CW , u} \cdot {L}_{LDPC , u} \cdot ( 1 - {R}_{u} ) ) AND ( {N}_{shrt} < 1.2 \cdot {N}_{punc , u} \cdot {R}_{u} / ( 1 - {R}_{u} ) )$$

is true; OR if

$${N}_{p u n c , u} > 0.3 \cdot {N}_{CW , u} \cdot {L}_{LDPC , u} \cdot ( 1 - {R}_{u} )$$

is true, for any user u, a set of (such as all) users with LDPC encoding may increment N_{avbits,u} by an extra symbol segment and recompute N_{punc,u} based on the new N_{avbits,u} value.

$${N}_{avbits , u} = \{ \begin{matrix}{N}_{avbits , u} + {N}_{CBPS , u} - 3 {N}_{CBPS , short , u} , & if {a}_{init} = 3 \\ {N}_{avbits , u} + {N}_{CBPS , short , u} , & otherwise\end{matrix}$$

The wireless communication device may update the common pre-FEC padding factor a and N_{SYM} values for a set of (such as all) users using the following:

$$\{ \begin{matrix}{N}_{SYM} = {N}_{SYM , init} + 1 and a = 1 , & if {a}_{init} = 4 \\ {N}_{SYM} = {N}_{SYM , init} and a = {a}_{i n i t} + 1 , & otherwise\end{matrix}$$

In some aspects, the last OFDM symbol may be the next OFDM symbol of the initial last OFDM symbol in this case, if aᵢₙᵢₜ=4. Because N_{avbits,u} may be updated with a larger value, more PHY coded bits may fit in the adjusted PHY coded bits boundary, which may be the end of the symbol segment a in the OFDM symbol N_{SYM}.

Alternatively, if the above condition in LDPC encoding process is not met by any of the users with LDPC encoding, or if a set of (such as all) the users scheduled in an EHT MU PPDU are BCC encoded, no extra symbol segment may be added. The wireless communication device may update the common pre-FEC padding factor a and N_{SYM} values for a set of (such as all) users using the following:

$${N}_{SYM} = {N}_{SYM , init} and a = {a}_{init}$$

The wireless communication device may compute the quantity of coded bits to be repeated for user u, N_{rep,u}, as follows:

$${N}_{rep , u} = max ( 0 , {N}_{avbits , u} - {N}_{CW , u} \cdot {L}_{LDPC , u} \cdot ( 1 - {R}_{u} ) - {N}_{pld , u} )$$

If N_{rep,u}=0, repetition may not be performed. If N_{rep,u}>0, the quantity of coded bits to be repeated may be equally distributed over all N_{CW,u} codewords with one more bit repeated for the first rem (N_{rep,u}, N_{CW,u}) codewords than the remaining codewords. The coded bits to be repeated for any codeword may be copied from that codeword itself, starting from the beginning of that LDPC codeword (beginning of data bits). In some aspects, if puncturing occurs, the coded bits are not repeated, and vice versa.

In a fifth step of LD PC rate matching, the wireless communication device may finalize the LDPC/BCC pre-FEC padding and post-FEC padding. For the users with LDPC encoding, the wireless communication device may update NDBPS of the last OFDM symbol as:

$${N}_{DBPS , last , u} = {N}_{DBPS , last , init , u}$$

For the users with BCC encoding, the wireless communication device may update NDBPS of the last OFDM symbol as:

$${N}_{DBPS , last , u} = \{ \begin{matrix}a \cdot {N}_{DBPS , short , u} , & if a < 4 \\ {N}_{DBPS , u} , & if a = 4\end{matrix}$$

For each user with either LDPC or BCC encoding, the wireless communication device may update NCBPS of the last OFDM symbol as:

$${N}_{CBPS , last , u} = \{ \begin{matrix}a \cdot {N}_{CBPS , short , u} , & if a < 4 \\ {N}_{CBPS , u} , & if a = 4\end{matrix}$$

For each user with LDPC encoding, the quantity of pre FEC padding bits for the u-th user may be computed as in the following equation.

$${N}_{PAD , Pre - FEC , u} = ( {N}_{SYM , init} - 1 ) {N}_{DBPS , u} + {N}_{DBPS , last , init , u} - 8 \cdot {APEP}_{{LENGTH}_{u}} - {N}_{service}$$

In some aspects, the PHY payload boundary (such as the pre-FEC padding boundary) for users using LDPC encoding may still be the end of the symbol segment aᵢₙᵢₜ in the OFDM symbol N_{SYM,init}, determined by N_{SYM,init} and aᵢₙᵢₜ.

For the users with BCC encoding, the quantity of pre-FEC padding bits for the u-th user is shown in the following equation.

$${N}_{PAD , Pre - FEC , u} = ( {N}_{SYM} - 1 ) {N}_{DBPS , u} + {N}_{DBPS , last , u} - 8 \cdot {APEP}_{{LENGTH}_{u}} - {N}_{tail , u} - {N}_{service}$$

In some aspects, for users using BCC encoding, both the PHY payload boundary (such as the pre-FEC padding boundary) and the PHY coded bits boundary may be the same as the end of the symbol segment a in the OFDM symbol N_{SYM}, determined by N_{SYM} and a.

For each user with either LDPC or BCC encoding, the quantity of post-FEC padding bits in the last symbol may be computed as in the following equation.

$${N}_{PAD , Post - FEC , u} = {N}_{CBPS , u} - {N}_{CBPS , last , u}$$

In some aspects, the post-FEC padding may fill the data tones not occupied by PHY coded bits in the last OFDM symbol, such as the remaining symbol segments in the last OFDM symbol. Among the pre-FEC padding bits, the MAC entity or layer may deliver a PSDU that fills the available octets in the Data field of the EHT PPDU, toward the (expected) initial pre-FEC padding boundary represented by aᵢₙᵢₜ for users encoded by LDPC, and toward the (expected) pre-FEC padding boundary represented by a for users encoded by BCC, in the last OFDM symbol of the Data field. The PHY entity or layer may determine the quantity of padding bits to add and appends them to the PSDU. The quantity of pre-FEC padding bits added by the PHY entity or layer may be in a range of 0 to 7.

In some systems, such an LDPC rate matching scheme may lack compatibility with other wireless communication schemes. For instance, such an LDPC rate matching scheme may lack compatibility with a probability constellation shaping scheme. For example, in probability constellation shaping, the PHY payload size may change in the shaping process. The payload size after shaping may depend on the input bitstream and may not be known until shaping is finished (such as completed). If the payload size after shaping is known, a wireless communication device could use it in the rate matching to calculate a pre-FEC padding boundary and a PHY coded bits boundary. In some systems, however, the wireless communication device may be expected to signal the PPDU duration in an L-SIG and the pre-FEC padding factor in a preamble before a Data field is processed (before shaping is done). Thus, the payload size after shaping may remain unknown when rate matching is calculated. For further example, in probability constellation shaping, the systematic bits may be or may include shaped bits and may be used as amplitude bits in a QAM mapping, while sign bits may come from parity bits. For an accurate QAM mapping, there may be an expectation to keep a specific ratio of amplitude bits and sign bits. Hence, to be compatible with constellation shaping, the wireless communication device may expect to keep (such as maintain) a specific effective code rate and may not let the code rate be determined in the LDPC rate matching processing, as is allowed or expected in some systems, as such a code rate determined in the LDPC rate matching processing may disrupt the QAM mapping in constellation shaping.

In accordance with some example implementations of the present disclosure, a wireless communication device (such as an AP 102 or a STA 104) may support one or more configuration- or signaling-based mechanisms to support rate matching in probability constellation shaping in various systems, including Wi-Fi systems. For example, in some implementations, a wireless communication device may perform a rate matching process associated with shaped data to be transmitted in accordance with determining a pre-FEC padding boundary denoted by (N_{SYM}, a), a pre-FEC padding size, a quantity of codewords N_{CW}, and a post-FEC padding size given a presumed (estimated) payload size after shaping, a constellation shaped codeword size L_{CS}, and an effective code rate (such as a target effective code rate) R_{eff}. Similarly, a wireless communication device may receive a rate matched packet and may parse/decode the packet in accordance with determining a quantity of codewords N_{CW} and a post-FEC padding size associated with the packet given (such as in association with obtaining information indicative of) a constellation shaped LD PC codeword size L_{CS}, an effective code rate R_{eff}, and a pre-FEC padding boundary denoted by (N_{SYM}, a).

Additionally, or alternatively, two or more wireless communication devices may participate in a signaling mechanism to convey information associated with an application of constellation shaping. In some implementations, a wireless communication device may indicate a constellation shaping combination via one or more fields of a frame, such as via an MCS subfield of a user info field. For example, one or more codepoints associated with an MCS subfield may correspond to or otherwise indicate a constellation shaping combination. Additionally, or alternatively, a wireless communication device may signal an indication of whether constellation shaping is ON or OFF. Such an indication may be a 1-bit indication and may be present within a common info field (to toggle constellation shaping ON or OFF for all devices receiving the frame) or a user info field (to toggle constellation shaping ON or OFF for a specific device associated with the user info field). In some implementations, such a 1-bit indication and an MCS subfield may jointly signal a constellation shaping combination. A constellation shaping combination may refer to one or more of a shaper rate (according to a QAM and an FEC code rate, or a combined shaper rate according to a pattern of shaper rates which are according to a pattern of equal or unequal modulation schemes and an FEC code rate), a QAM or a pattern of QAMs (such as a pattern of equal or unequal modulation schemes), and an FEC code rate. A pattern of QAM s or a pattern of modulation schemes may refer generally to an equal modulation pattern across a set of spatial streams or an unequal modulation pattern across the set of spatial streams with a common code rate.

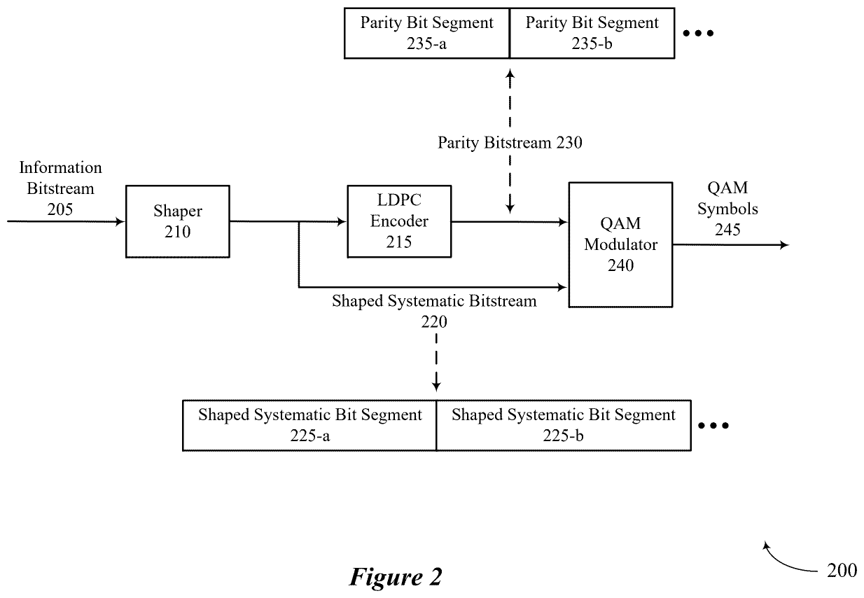

FIG. 2 shows an example transmission diagram 200 associated with an application of a probability constellation shaping to an information bitstream. The transmission diagram 200 may implement or be implemented to realize one or more aspects of the wireless communication network 100. For example, a wireless communication device (such as a transmitter device, which may be an AP 102 or a STA 104) may implement at least some aspects of the transmission diagram 200 to support LDPC rate matching in constellation shaping, including in Wi-Fi systems.

In some wireless communications systems, such as a Wi-Fi network, wireless devices (such as transmitters and receivers), such as APs 102 and STAs 104, may support the use of various MCSs to transmit and receive data so as to account for (such as to configure wireless communication based on) wireless channel conditions, for example, to increase throughput, reduce latency, or enforce various QoS parameters. For example, some systems (such as systems employing the IEEE 802.11ax standard amendment protocols) may support the use of QAM, in which a bitstream may be input into a QAM modulator 240 to form QAM symbols 245, which may be mapped to subcarriers of one or more OFDM symbols for transmission (such as using a single spatial stream, Nₛₛ=1).

In some aspects (such as aspects in which Nₛₛ=1), an encoder, such as an LDPC encoder 215, of a transmitting wireless device may receive an information bitstream 205, may generate a systematic bitstream correspond to the information bitstream 205, and may encode (and, in some aspects, rate match) the information bitstream 205 to generate a parity bitstream 230 (and, in some aspects, repetition bits). In some examples, the parity bitstream 230 may be associated with (such as based on) the information bitstream 205. A serializer (of the transmitting wireless device) at an output of the LDPC encoder 215 may receive the systematic bitstream and the parity bitstream 230 and may construct one or more LDPC codewords (in accordance with a codeword grouping). In some examples, each LDPC codeword may include a group of systematic bits (such as from the systematic bitstream), which may be referred to as a systematic bit segment, appended with a group of parity bits (such as from the parity bitstream 230), which may be referred to as a parity bit segment 235. In such examples, the one or more LDPC codewords may form a single, serialized bitstream to be fed to a single QAM modulator 240. Thus, for a single spatial stream (such as Nₛₛ=1), the single QAM modulator 240 (such as of the transmitting wireless device) may receive the serialized bitstream and may generate one or more QAM symbols 245 in accordance with the received serialized bitstream.

In some aspects, transmitting wireless devices also may support multiple spatial streams (such as Nₛₛ≥2). In such aspects, an encoder, such as an LDPC encoder 215, of a transmitting wireless device may receive an information bitstream 205, may generate a systematic bitstream correspond to the information bitstream 205, and may encode (and rate match) the information bitstream 205 to generate a parity bitstream 230 (and repetition bits), with the parity bitstream 230 being associated with the information bitstream 205. A serializer (such as of the transmitting wireless device) at an output of the LDPC encoder 215 may receive the systematic bitstream and the parity bitstream 230 and may construct one or more LDPC codewords (such as codeword grouping), with each LDPC codeword including a group of systematic bits (such as from the systematic bitstream), which may be referred to as a systematic bit segment, appended with a group of parity bits (such as from the parity bitstream 230), which may be referred to as a parity bit segment 235. In such examples, the one or more LD PC codewords may form a single, serialized bitstream to be fed to a stream parser to further be fed to one or more QAM modulators 240.

In some examples, for multiple spatial stream (such as Nₛₛ≥2), the stream parser may form groupings of bits (such as of the serialized bitstream) to distribute (such as in a round robin fashion) to multiple QAM modulators 240, with each of the QAM modulators 240 being associated with a spatial stream of the multiple spatial streams. In other words, each QAM modulator 240 of the multiple QAM modulators 240 may receive multiple groupings of bits (such as chunks of bits), such that each QAM modulator 240 receives a portion of the serialized bitstream. In some examples, such as in examples of equal modulation MIMO, each grouping of bits may include N_{qam}/2 bits, where N_{qam} may be a quantity of bits used to form a QAM symbol 245, such that each grouping of bits received by a QAM modulator 240 may be either an ‘I’ portion (such as In-phase component) or a ‘Q’ portion (such as Quadrature component) of a QAM symbol 245. In some other examples, such as in examples of unequal modulation MIMO, groupings of bits fed to each QAM modulator 240 may not be the same in association with modulation orders across the multiple spatial streams being different. For example, each grouping of bits fed to a first QAM modulator 240 may include N_{qam,1}/2 bit and each grouping of bits fed to a second QAM modulator 240 may include N_{qam,2}/2 bit, where N_{qam,1}/2 may be a first quantity of bits used to form a QAM symbol 245 of a first modulation order associated with the first QAM modulator 240 (such as for a first spatial stream) and N_{qam,2}/2 may be a second quantity of bits used to form a QAM symbol 245 of a second modulation order associated with the second QAM modulator 240 (such as for a second spatial stream). In either examples, each QAM modulator 240 of the multiple QAM modulators 240 may perform modulation separately, based on a respective portion of the serialized bitstream received by the QAM modulator 240, to generate a respective set of QAM symbols 245 for an associated spatial stream of the multiple spatial streams.

To generate one or more QAM symbols 245, the QAM modulator 240 may map incremental groups of bits (such as systematic bits, parity bits, or both) from the serialized bitstream to constellation points (such as symbols) of a constellation associated with the QAM modulator 240, where each constellation point represents a QAM symbol 245. That is, the (or each) QAM modulator 240 may use a specific MCS for generation of the one or more QAM symbols 245, where the MCS defines at least one of the constellation, the modulation order of the one or more QAM symbols, and a size of the group of bits (such as group sizing). In such cases, the constellation may be associated with a uniform distribution. In other words, values (such as 0 or 1) of each bit of the serialized bitstream may be equally likely, such that each constellation point of the constellation may be associated with an equal (such as same) usage frequency (such as probability or likelihood of use). However, different constellation points may be associated with different energy and average power (such as for transmission). That is, the constellation points may be arranged on a grid defined by a horizontal axis (such as | component) and a vertical axis (such as Q component), where constellation points located further from an origin (such as intersection of the horizontal axis and vertical axis) are associated with a higher energy than constellation points located closer to the origin. Thus, some signals may be generated based on a set of constellation points that are located further from the origin, resulting in high average power.

Accordingly, in some implementations, the transmitting wireless device may perform constellation shaping on the information bitstream 205, such that the constellation (such as associated with the QAM modulator 240) may be associated with a non-uniform distribution in which constellation points of the constellation are associated with variable usage frequencies. In such implementations, the variable usage frequencies may result in constellation points closer to the origin being associated with a higher usage frequency than those located further from the origin. Such a non-uniform distribution may result in a Gaussian distribution of energy associated with a signal (such as generated based on QAM symbols 245 output from the QAM modulator 240), which may enable the signal to attain a threshold (such as maximum) entropy, or ability to carry information, while remaining within a threshold (such as maximum) average power consumption associated with the transmitting wireless device.

To support constellation shaping, the transmitting wireless device may include a shaper 210 prior to the LDPC encoder 215 to shape the information bitstream 205 into a shaped systematic bitstream 220 (corresponding to the information bitstream 205), such that values (0 or 1) of each bit of the shaped systematic bitstream 220 may not be equally likely (may be associated with a non-uniform distribution), which may result in a non-uniform distribution of a constellation associated with the QAM modulator 240. In such implementations, the non-uniform distribution may be associated with a structure of the shaped systematic bitstream 220 (such as the structure of the shaped systematic bits in the shaped systematic bitstream 220 may be associated with the shaping). In some systems, the transmitting wireless device may encode the shaped systematic bitstream 220 to generate a parity bitstream 230, where the parity bitstream 230 may be associated with the shaped systematic bitstream 220. The serializer at the output of the LDPC encoder 215 may receive the shaped systematic bitstream 220 and the parity bitstream 230 and may construct a serialized bitstream of one or more LDPC codewords, where each LDPC codeword includes a shaped systematic bit segment 225 appended with a parity bit segment 235. Thus, the QAM modulator 240 may receive the serialized bitstream output by the serializer and may generate one or more QAM symbols 245 based on the serialized bitstream.

In some implementations, a transmitting wireless device may support a mechanism of constellation shaping to avoid negating the shaping in association with generating one or more QAM symbols 245 based on a single serialized bitstream (such as to avoid mapping the bits of the single serialized bitstream to constellation points that may result in an unintended non-uniform distribution that may not result in a Gaussian distribution of energy). In some examples, the transmitter may support constellation shaping for a single spatial stream (such as Nₛₛ=1). For example, a shaper 210 may receive an information bitstream 205 (such as set of information bits) and may shape (such as alter) bits of the information bitstream 205 such that, by the end of a QAM modulation process (such as at a QAM modulator 240), a frequency usage of constellation points (such as of a given QAM modulation order associated with the QAM modulator 240) may be probabilistically shaped to be non-uniform (such as be associated with a non-uniform distribution). Thus, the shaper 210 may output a shaped systematic bitstream 220 (such as including a set of shaped systematic bits) associated with a given structure (such as based on the shaping), where the shaped systematic bitstream 220 corresponds to the information bitstream 205. In such cases, the structure may be generated such that shaped systematic bits of the shaped systematic bitstream 220 may not be altered and the shaped systematic bitstream 220 may not be segmented or broken up.

An LDPC encoder 215 (and rate matcher) may receive the shaped systematic bitstream 220 from the shaper 210 and may generate a parity bitstream 230 (and repetition bits) based on the shaped systematic bitstream 220. In some examples, the parity bitstream 230 may include one or more parity bit segments 235 and the shaped systematic bitstream 220 may include one or more shaped systematic bit segments 225, where a combination of a parity bit segment 235 and a shaped systematic bit segment 225 may form an LDPC codeword. For example, a first LDCP codeword may include a parity bit segment 235-a and a shaped systematic bit segment 225-a and a second LDPC codeword may include a parity bit segment 235-b and a shaped systematic bit segment 225-b. Thus, the one or more parity bit segments 235 and the one or more shaped systematic bit segments 225 may form up to N (such as one or more) LDPC codewords.

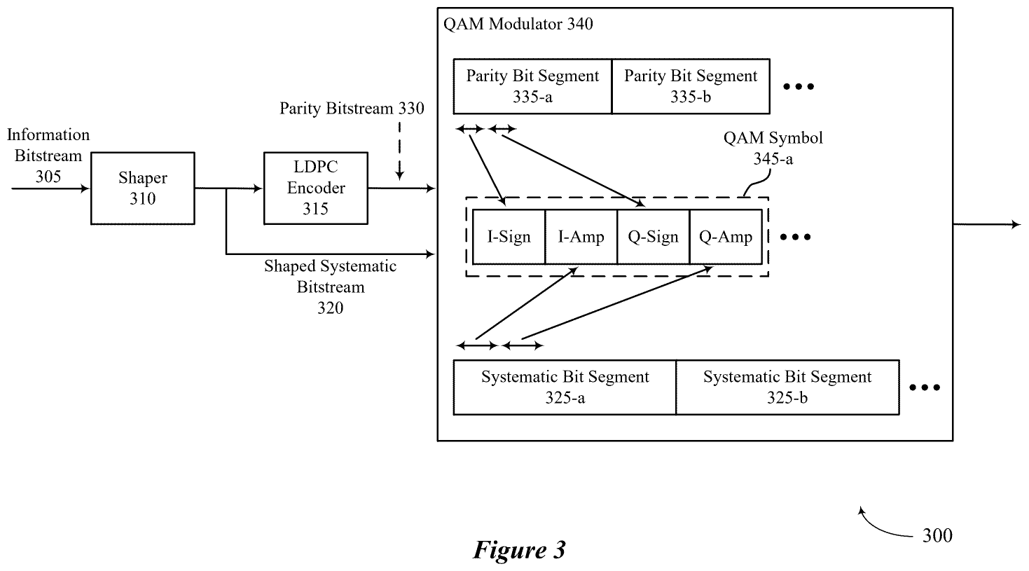

The QAM modulator 240 may receive the parity bitstream 230 (and repetition bits) as a first stream of bits and the shaped systematic bitstream 220 as a second stream of bits. In other words, the QAM modulator 240 may receive two separate inputs (such as rather than one serially concatenated input). Receiving the shaped systematic bitstream 220 as a separate stream of bits may enable the QAM modulator 240 to maintain the structure of the shaped systematic bitstream 220, which may result in the frequency usage of the constellation points (such as of the given QAM modulation order associated with the QAM modulator 240) to be probabilistically shaped to be non-uniform, as described further with reference to FIG. 3.

Thus, the QAM modulator 240 may output one or more QAM symbols 245 and the transmitter (such as or another component of the transmitter) may map the one or more QAM symbols 245 to one or more subcarriers of one or more OFDM symbols to be transmitted by the transmitter. The transmitter may transmit a signal associated with the one or more QAM symbols 245, where the signal is associated with a Gaussian distribution of energy based on the non-uniform probabilistically shaping of the constellation points at the QAM modulator 240.

Additionally, or alternatively, the transmitter may support constellation shaping for multiple spatial stream (such as Nₛₛ≥2). For example, a shaper 210 may receive an information bitstream 205 (such as set of information bits) and may shape (such as alter) bits of the information bitstream 205 into a shaped systematic bitstream 220 such that, by the end of a QAM modulation process (such as at one or more QAM modulators 240), a frequency usage of constellation points (such as of a given QAM modulation order associated with each QAM modulator 240) may be probabilistically shaped to be non-uniform (such as be associated with a non-uniform distribution). Thus, the shaper 210 may output a shaped systematic bitstream 220 associated with a given structure (such as based on the shaping), where the shaped systematic bitstream 220 may correspond to the information bitstream 205. In such cases, structure may be generated such that shaped systematic bits of the shaped systematic bitstream 220 may not be altered and the shaped systematic bitstream 220 may not be segmented or broken up. An LDPC encoder 215 (and rate matcher) may receive the shaped systematic bitstream 220 from the shaper 210 and may generate a parity bitstream 230 (and repetition bits) based on the shaped systematic bitstream 220.

In some examples, a single QAM modulator 240 (such as of the transmitter) may receive the parity bitstream 230 (and repetition bits) as a first stream of bits and the shaped systematic bitstream 220 as a second stream of bits. In other words, the QAM modulator 240 may receive two separate inputs (such as rather than one serially concatenated input). Receiving the shaped systematic bitstream 220 as a separate stream of bits may enable the QAM modulator 240 to maintain the structure of the shaped systematic bitstream 220, which may result in the frequency usage of the constellation points (such as of the given QAM modulation order associated with the QAM modulator 240) to be probabilistically shaped to be non-uniform. Thus, the QAM modulator 240 may generate multiple QAM symbols 245 based on the parity bitstream 230 (and repetition bits) and the shaped systematic bitstream 220.

Additionally, to support multiple spatial streams, a stream parser may distribute the multiple QA M symbols 245 across the multiple spatial streams. In such cases, the stream parser may distribute the multiple QAM symbols 245 one at a time in a round-robin fashion across the multiple spatial streams (such as until all of the multiple QAM symbols 245 have been distributed). That is, the stream parser may distribute a first QAM symbol 245 to a first spatial stream of the multiple spatial streams, a second QAM symbol 245 to a second spatial stream of the multiple spatial streams, and so on until a last spatial stream of the multiple spatial streams, at which point the stream parser may return to the first spatial stream to repeat the distribution cycle. For example, a wireless communication device use transmit via 2 spatial streams, such that the stream parser may distribute a first set of one or more QAM symbols 245 for a first spatial stream and a second set of one or more QAM symbols 245 for a second spatial stream. Additionally, for each set of QAM symbols 245, the transmitter (or a component of the transmitter) may map the set of QAM symbols 245 to a respective spatial stream of one or more subcarriers of one or more OFDM symbols be transmitted by the transmitter via a respective spatial stream.

In some other examples, parsing (such as bitstream parsing) may occur prior to modulation. In such examples, the transmitter may include two stream parsers, including a parity bitstream parser and a systematic bitstream parser. The parity bitstream parser may receive the parity bitstream 230 and may distribute the parity bitstream 230 across multiple QAM modulators 240 (such as until all parity bits of the parity bitstream 230 have been distributed), where each QAM modulator 240 is associated with a spatial stream of the multiple spatial streams (such as QA M modulation may be performed independently for each spatial stream). Similarly, the systematic bitstream parser may receive the shaped systematic bitstream 220 and may distribute the shaped systematic bitstream 220 across the multiple QAM modulators 240 (such as until all shaped systematic bits of the shaped systematic bitstream 220 have been distributed). The parity bitstream parser may distribute 1 bit to each of the QAM modulators 240 (such as of the multiple QAM modulators 240) in a round-robin fashion and the systematic bitstream parser may distribute (N_{qam}−2)/2 bit tuples to each of the QAM modulators 240 (such as of the multiple QAM modulators 340) in a round-robin fashion, where N_{qam} may represent a quantity of bits per QAM symbol 245 of a modulation order associated with (such as used by) the multiple QAM modulators 240.

Each QAM modulator 240 of the multiple QAM modulators 240 may generate one or more QAM symbols 245 to be put on a respective spatial stream of one or more subcarriers in one or more OFDM symbols to be transmitted. For example, a wireless communication device may transmit via two spatial streams, such that the parity bitstream parser may distribute the parity bitstream 230 to a first QAM modulator 240 and a second QAM modulator 240, and the systematic bitstream parser may distribute the shaped systematic bitstream 220 to the first QAM modulator 240 and the second QAM modulator 240. Thus, the first QAM modulator 240 may generate one or more QAM symbols 245 for a first spatial stream and the second QAM modulator 240 may generate one or more QAM symbols 245 for a second spatial stream. The wireless communication device may support equal modulation or unequal modulation across the multiple spatial streams.

Though some examples may be described in the context of two spatial streams, this is not to be regarded as a limitation of the present disclosure. In this regard, the techniques described herein may support any quantity of spatial streams.

FIG. 3 shows an example modulation scheme 300 that illustrates a mapping of systematic bits and parity bits to modulation symbols in accordance with an application of a probability constellation shaping to an information bitstream. The modulation scheme 300 may implement or be implemented to realize one or more aspects of the wireless communication network 100 or the transmission diagram 200. For example, a wireless communication device (such as a transmitter device, which may be an AP 102 or a STA 104) may implement at least some aspects of the modulation scheme 300 to support LD PC rate matching in constellation shaping, including in Wi-Fi systems.

In some aspects, constellating shaping works in a system by a shaper 310 forming output information bit groups (such as tuples) that represent (and will map to) I component or Q component (PA M) amplitudes of QAM symbols 345, where the amplitude values are associated with a desired distribution (as shaped by the shaper 310). This method of shaping to PAM amplitudes may be used because it may pair directly with LDPC encoding, where LD PC may be a so-called systematic code in that the input into an LDPC encoder 315 to may appear directly in an output codeword (such as LDPC codeword) with no modification. Thus, LDPC encoders 315 may preserve the input bits and arranged group structure coming out of the shaper 310 as a shaped systematic bitstream 320 (such as set of shaped systematic bits). In such cases, a parity bitstream 330 generated by the LD PC encoder 315 may not be considered shaped and can be assumed to be equiprobable 0s and 1s.

Some example implementations may enable a QAM modulator 340 to consider the arranged group structure to form constellation shaped QAM symbols 345. For example, a constellation shaped QAM symbol 345 may be formed by using shaped systematic bit groups to form I and Q component amplitudes for the QAM symbol 345, and using parity bits as signs for the I and Q components for the QAM symbol 345. Thus, the shaper 310 upstream may be generating bit group outputs (such as shaped systematic bit tuples), such that energy of the resulting set of QAM symbols 345 from all information bits of an information bitstream 305, taken together, form a Gaussian-like distribution. In some examples, energy of a QAM symbol 345 may not depend on a polarity (such as a sign) of the QAM symbol 345 and may depend on I and Q component amplitudes for the QAM symbol 345.

To use shaped systematic bit groups to form I and Q component amplitudes for the QAM symbol 345 and use parity bits to form signs for the I and Q components for the QAM symbol 345, a transmitter may receive separate streams of parity bits and shaped systematic bits and may employ the modulation scheme 300. According to the modulation scheme 300, a QAM modulator 340 may generate QAM symbols 345 without regard to LDPC codeword boundaries in the shaped systematic bits and the parity bits (and repetition bits). A shaper 310 may receive an information bitstream 305 and shape the information bits of the information bitstream 305 to produce a shaped systematic bitstream 320. An LDPC encoder 315 may receive the shaped systematic bitstream 320 and generate a parity bitstream 330 (such as parity bitstream) based on the shaped systematic bitstream 320.

Thus, the LDPC encoder 315 may produce ‘N’ LDPC codewords from the shaped systematic bitstream 320 (such as information bitstream 305 post shaping) according to an encoding rate ‘R,’ where each LDPC codeword includes a systematic bit segment 325 (such as subset of bits from the shaped systematic bitstream 320) and a parity bit segment 335 (such as subset of bits from the parity bitstream 330). For example, a first LDPC codeword may include a parity bit segment 335-a and a systematic bit segment 325-a, and a second LDPC codeword may include a parity bit segment 335-b and a systematic bit segment 325-b. The QAM modulator 340 may receive the parity bitstream 330 (such as parity bit bitstream) and the shaped systematic bitstream 320 (such as shaped systematic bitstream) and may direct the two separate bitstreams to two separate queues. A first queue, which may be referred to as a parity queue, may include the parity bits (and repetition bits) of all LDPC codewords (such as the parity bitstream), arranged serially, and a second queue, which may be referred to as a systematic queue, may include the shaped systematic bits of all LDPC codewords (such as the shaped systematic bitstream 320), arranged serially. Bits of LDPC codewords (such as shaped systematic bits and parity bits) may be referred to as coded bits of the LDPC codewords.

The QAM modulator 340 may generate (such as form) QAM symbols 345 for the ‘N’ LDPC codewords according to two phases (such as if needed). In some cases (such as equal modulation MIMO), in a first phase, the QAM modulator 340 may start at a beginning of each queue and form a QAM symbols 345-a by consuming bits from the queues as follows:
1. Draw (such as pull, map) 1 bit from the parity bit queue (such as regardless of associated LDPC codeword) to be a sign of an I-component (such as I-sign) of a QAM symbol 345-a.
2. Draw (N_{qam}−2)/2 bits from the systematic queue (such as regardless of associated LDPC codeword) to be an amplitude of the I-component (such as I-amp) of the QAM symbol 345-a.
3. Draw a next (such as subsequent) 1 bit from the parity bit queue (such as regardless of associated LDPC codeword) to be a sign of a Q-component (such as Q-sign) of the QAM symbol 345-a.
4. Draw a next (N_{qam}−2)/2 bits from the systematic queue (such as regardless of associated LDPC codeword) to be an amplitude of the Q-component (such as Q-amp) of the QAM symbol 345-a.

The QAM symbol 345-a may be a first QAM symbol to be output by the QAM modulator 340, such that steps 1-4 may be repeated one or more times if there are sufficient bits in each queue to complete a QAM symbol 345 (such as for equal modulation MIMO). That is, the QAM modulator 340 may repeat steps 1-4 until either the parity queue, the systematic queue, or both, run out of bits to complete a QAM symbol 345 (such as the parity queue has less than 2 bits, the systematic queue has less than N_{qam}−2 bits). In some examples, all bits may be consumed from both of the parity queue and the systematic, such that the QAM modulator 340 may complete modulation (such as without moving to phase 2). In some other cases, either the parity queue, the systematic queue, or both, may include remaining bits, where a QAM symbol 345 may not be formed using the remaining bits, such that the QAM modulator 340 may move to a second phase of modulation.

In some examples, the QAM modulator 340 may not be able to form a QAM symbol 345 in accordance with the parity queue not having enough bits (such as when

$$\frac{R}{1 - R} > \frac{{N}_{qam} - 2}{2} ) .$$

In such examples, the QAM modulator 340 may complete the second phase of modulation according to the following steps:
1. The QAM modulator 340 may calculate a location ‘X’ in the systematic queue according to the following Equation 1 (such as assuming zero-indexing of the queues):

$$X = {N}_{qs , total} \times ( {N}_{qam} - 2 ) \qquad ( 1 )$$

$${N}_{qs , total} = ⌈ \frac{{N}_{avbits}}{{N}_{QAM}} ⌉ ,$$

a total quantity of QAM symbols 345 to be generated from coded bit of all of the LDPC codewords
N_{QAM}=a total quantity of the coded bits of all of the LDPC codewords
N_{avbits}=a total number of bits per QAM symbol 345 in a single spatial stream and equal modulation MIMO
2. The QAM modulator 340 may move a portion of the systematic queue from location ‘X’ until an end of the systematic queue to be an extension of the parity queue (and removed from the systematic queue).
3. The QAM modulator 340 may continue forming QAM symbols 345 with sign bits (such as bits for I-Sign and Q-Sign) being drawn from the extension to the parity queue and amplitude bits (such as bits for I-Amp and Q-Amp) being drawn from the truncated systematic queue.
4. Once no more QAM symbols 345 may be fully formed (such as including complete I and Q components) due to either the end of the extended parity queue or the truncated systematic queue being reached, the QAM modulator 340 may insert pad bits to complete a last QAM symbol 345 (such as if necessary) and may finish QAM modulation of a payload (such as the information bitstream 305).

In some other examples, the QAM modulator 340 may not be able to form a QAM symbol 345 in accordance with the systematic queue not having enough bits (such as when

$$\frac{R}{1 - R} < \frac{{N}_{qam} - 2}{2} ) .$$

In such examples, the QAM modulator 340 may complete the second phase of modulation according to the following steps:
1. The QAM modulator 340 may calculate a location ‘Y’ in the parity queue according to the following Equation 2 (such as assuming zero-indexing of the queues):

$$Y = {N}_{qs , total} \times 2 \qquad ( 2 )$$

2. The QAM modulator 340 may move a portion of the parity queue from location ‘Y’ until an end of the parity queue to be an extension of the systematic queue (and removed from the parity queue).
3. The QAM modulator 340 may continue forming QAM symbols 345 with sign bits (such as bits for I-Sign and Q-Sign) being drawn from the truncated parity queue and amplitude bits (such as bits for I-Amp and Q-Amp) being drawn from the extension of the systematic queue.
4. Once no more QAM symbols 345 may be fully formed (such as including complete I and Q components) due to either the end of the truncated parity queue or the extended systematic queue being reached, the QAM modulator 340 may insert pad bits to complete a last QAM symbol 345 (such as if necessary) and may finish QAM modulation of a payload (such as the information bitstream 305).

In some examples (such as unequal modulation MIMO), the QAM modulator 340 may use a different quantity of bits from the systematic queue (such as systematic bitstream) for each QAM symbol 345 (such as at least one of the QAM symbols 345 generated by the QAM modulator 340). In such examples, as the QAM modulator 340 is consumes (such as uses) bits from the systematic queue, the QAM modulator 340 may track what QAM modulation order amplitude it may produce for a given QAM symbol 345 in accordance with a position in the systematic queue (such as systematic bitstream) and a previous amplitude produced by the QAM modulator 340 for a previous QAM symbol 345.

For example, in a first phase, the QAM modulator 340 may start at a beginning of each queue and form a QAM symbols 345-a by consuming bits from the queues as follows:
1. Draw (such as pull, map) 1 bit from the parity bit queue to be a sign of an I-component (such as I-sign) of a QAM symbol 345-a.
2. Draw a first quantity of bits from the systematic queue to be an amplitude of the I-component (such as I-amp) of the QAM symbol 345-a, where the first quantity may be based on a first QAM modulation order associated with a first spatial stream (such as with a spatial stream index, ‘ss_{idx},’ of 0).
3. Draw a next (such as subsequent) 1 bit from the parity bit queue to be a sign of a Q-component (such as Q-sign) of the QAM symbol 345-a.
4. Draw the first quantity of bits from the systematic queue to be an amplitude of the Q-component (such as Q-amp) of the QAM symbol 345-a.

The QAM symbol 345-a may be a first QAM symbol 345 to be output by the QAM modulator 340, such that steps 1-4 may be repeated one or more times if there are sufficient bits in each queue to complete a QAM symbol, where a quantity of bits drawn for an amplitude of an I component and a Q component of a QAM symbol 345 may be variable during each repetition and may depend on a QAM modulation order associated with a respective spatial stream. For example, steps 1-4 may be repeated for a QAM symbol 345-b (such as not depicted), where the first quantity is updated to a second quantity associated with a second QAM modulation order further associated with a second spatial stream (such as with a spatial stream index, ‘ss_{idx},’ of 1). The QAM modulator 340 may continue this repetition process until a QAM symbol 345 associated with a last spatial stream (such as with a spatial stream index, ‘ss_{idx},’ of Nₛₛ), after which the QAM modulator 340 may loop back to producing a QAM symbol 345 for the first spatial stream and continue to loop in this round-robin fashion until either the systematic queue, the parity queue, or both, run out of bits.

Further, although the modulation scheme 300 illustrates an example in which Nₛₛ=1, the disclosed implementations may be extended and applicable to examples in which Nₛₛ≥2. In other words, the techniques of the present disclosure may support any quantity of spatial streams. In examples in which Nₛₛ≥2, a wireless communication device may use one or more stream parsers and a (such as one) QAM mapper (such as a QAM modulator 340) per stream. For example, a stream parser may distribute the multiple QAM symbols 345 across the multiple spatial streams. In such examples, the stream parser may distribute the multiple QAM symbols 345 one at a time in a round-robin fashion across the multiple spatial streams (such as until all of the multiple QAM symbols 345 have been distributed).

For example, the stream parser may distribute a first QAM symbol 345 to a first spatial stream of the multiple spatial streams, a second QAM symbol 345 to a second spatial stream of the multiple spatial streams, and so on until a last spatial stream of the multiple spatial streams, at which point the stream parser may return to the first spatial stream to repeat the distribution cycle. For example, a wireless communication device use transmit via 2 spatial streams, such that the stream parser may distribute a first set of one or more QAM symbols 345 for a first spatial stream and a second set of one or more QAM symbols 345 for a second spatial stream. Additionally, for each set of QAM symbols 345, the transmitter (or a component of the transmitter) may map the set of QAM symbols 345 to a respective spatial stream of one or more subcarriers of one or more OFDM symbols be transmitted by the transmitter via a respective spatial stream.

Further, in examples in which an unequal modulation pattern is used, according to which each stream of set of streams may be associated with a separately defined/indicated modulation scheme (such that a first spatial stream is associated with a first modulation scheme and a second spatial stream is associated with a second modulation scheme), the wireless communication device may use a different QAM mapper for different streams. For example, the wireless communication device may use a first QAM mapper for a first spatial stream and a second QAM mapper for a second spatial stream, with the first QAM mapper and the second QAM mapper being the same (such as for equal modulation patterns) or different (such as for unequal modulation patterns).

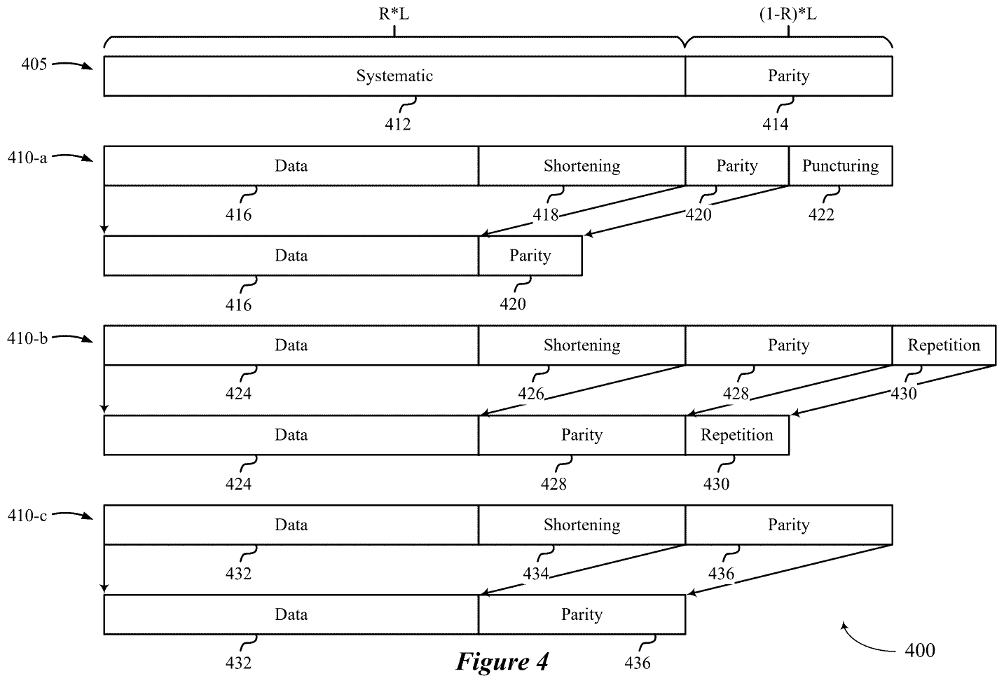

FIG. 4 shows an example LDPC codewords 400 that illustrate various codeword sizes depending on a presence of one or more shortening bits, one or more puncturing bits, one or more repeated bits, or any combination thereof. In probability constellation shaping, a PHY payload size may change in a shaping process. For example, a payload before shaping (excluding pre-FEC padding) may be defined as N_{pld,11n=}8*APEP_LEN+N_{SERVICE}. More generally, the PHY payload size before shaping or adding pre-FEC padding for user u may be denoted as N_{pld11n,u}=8. APEP_{LENGTH}_{ᵤ}+N_{service}. A payload after shaping may be defined as N_{pld,shaped} or, for user u, N_{pld,shaped,u}. Constellation shaping may be associated with a shaping rate Rₛₕₐₚₑ, which may be MCS (of equal or unequal modulation) dependent. In some aspects, systematic bits may be or include shaped bits and may be used as amplitude bits in a QAM mapping and parity bits may be used as sign bits in the QAM mapping.

In some aspects, an exact or final payload size after shaping may depend on an input bitstream and may be estimated as a function of the payload before shaping and the shaping rate. For example, the payload size after shaping and before adding pre-FEC padding for user u, N_{pld,shaped,u}, may be estimated as a function of the payload before shaping and the shaping rate, such as N_{pld,shaped,u,estimated}=f(N_{pld,11n}, Rₛₕₐₚₑ). In some aspects, this function may include a margin (such as 1%, 10%, etc.) in the size estimate, which may reduce a probability of an exact or final PHY payload size after shaping exceeding the estimate (such that the probably is lower than a threshold, such as less than a 0.1% chance or a 0 chance). In some aspects, such a margin may be a function of MCS.

To determine a codeword size, a first step may be to select a nominal LDPC codeword size. In some aspects, constellation shaping may not be used for small packets and may instead be used for large enough packets that use a largest LD PC nominal codeword size. In other words, a wireless communication device may (in accordance with a rule) determine, expect, assume, select, or otherwise ascertain that constellation shaping is not used for a subset of relatively smaller packets and is used for a subset of relatively larger packets (such as a subset of large enough packets that use a largest, or greater than a threshold, LDPC nominal codeword size). For example, if 2×LDPC (of codeword size 2×1944=3888) is not enabled, a wireless communication device may use a nominal codeword size of L_{LDPC}=1944. For further example, if 2×LDPC (of codeword size 2×1944=3888) is enabled, a wireless communication device may use nominal codeword size of L_{LDPC}=2× 1944=3888. Such a determination, expectation, assumption, or selection may facilitate or be associated with (such as triggered or enforced by) a rate matching process. In some aspects, because the effective code rate and puncturing ratio (such as no puncturing) may be determined in the QAM mapping process in probability constellation shaping, a wireless communication device may expect that using a largest (or larger than a threshold) nominal codeword size will likely provide a sufficient, suitable, or best performance.

A second step may be to determine the actual codeword size in transmission. In some aspects, probability constellation shaping may use a pre-defined amount of shortening (such as a fixed quantity of shortening bits per codeword) and a pre-defined amount of puncturing/repetition (such as a fixed quantity of punctured parity bits per codeword or a fixed quantity of repeated systematic bits per codeword) to reach a target effective code rate that allows the quantity of data bits (which is the difference between the quantity of systematic bits and the quantities of shortening bits) and the summation of quantity of unpunctured parity bits (which is the difference between the quantity of parity bits and the quantity of punctured bits) and the quantity of repeated bits to be proportional to amplitude bits and sign bits, respectively. In other words, in constellation shaping, a wireless communication device may use a fixed (such as pre-defined, pre-configured, signaled, or retrieved from memory) amount of shortening and a fixed (such as pre-defined, pre-configured, signaled, or retrieved from memory) amount of puncturing/repetition to reach a target effective code rate that allows, enables, or facilitates a quantity of data bits and the summation of quantity of unpunctured parity bits and the quantity of repeated bits to be proportional to a quantity of amplitude bits and a quantity of sign bits, respectively. In some implementations, the fixed amount of puncturing/repetition may include zero puncturing/repetition (such as no puncturing and no repetition).

In accordance with some example implementations, systematics bits may include or refer to data bits and zero or more shortening bits (with the data bits corresponding to shaped information bits). In other words, a quantity of data bits per codeword may be equal to a difference between a quantity of systematic bits per codeword and a quantity of shortening bits per codeword (which may be zero, one, or more). Data bits may be understood as data bits before repetition, such that repeated (data) bits may be selected from (the beginning of) the data bits. A quantity of systematic bits per codeword may be equal to a product of a nominal codeword size and a nominal code rate. Further, parity bits may include or refer to the output of an encoder (such as an LDPC encoder) before puncturing (if any). A quantity of parity bits per codeword may be equal to a product of a nominal codeword size and a value, where the value is the difference of a one value and a nominal code rate. A quantity of parity bits per codeword may be equal to the difference of a nominal codeword size and a quantity of systematic bits. Unpunctured parity bits may refer to (all) the parity bits output from the encoder in the absence of puncturing. Alternatively, unpunctured parity bits may refer to a subset of the parity bits output from the encoder in the presence of puncturing (such that one or more parity bits are punctured, with such bits being referred to herein or otherwise understood as punctured bits or punctured parity bits).

A quantity of shortening bits per codeword N_{spcw} may be given in a QAM mapping process as a function of RU size, MCS (with equal modulation or unequal modulation), Nₛₛ, and a nominal codeword size L_{LDPC}. In some aspects, if no puncturing and no repetition, a constellation shaped LDPC codeword size may be denoted as L_{CS}=L_{LDPC}−N_{spcw}. In some aspects, both a transmitter device and a receiver device may determine, obtain, ascertain, calculate, select, or otherwise identify the constellation shaped codeword size L_{CS}=L_{LDPC}−N_{spcw}, where L_{CS} may be understood as a codeword size in transmission (such as an actual or final codeword size). If a wireless communication device performs puncturing, L_{CS} may be equal to a quantity of data bits per codeword plus a quantity of parity bits per codeword (outputs from an LDPC encoder) minus a quantity of punctured bits per codeword. If a wireless communication device performs repetition (such as instead of puncturing), L_{CS} may be equal to a quantity of data bits per codeword before repetition plus a quantity of parity bits per codeword (outputs of an LDPC encoder) plus a quantity of repeated bits (with the repeated bits being selected from the beginning of the data bits).

An effective code rate may be defined in accordance with Equation 3, shown below.

$${R}_{eff} = \frac{{L}_{LDPC} \times R - {N}_{spcw}}{{L}_{CS}} \qquad ( 3 )$$

The example LDPC codewords 400 may include a nominal codeword 405, a codeword 410-a, a codeword 410-b, and a codeword 410-c. The nominal codeword 405 may be associated with a baseline codeword illustrative of a set of systematic bits 412 and a set of parity bits 414. In some aspects, a quantity of the set of systematic bits 412 may be associated with (such as equal to) R*L and a quantity of the set of parity bits 414 may be associated with (such as equal to) (1−R)*L, with R being a nominal code rate and L (or, equivalently, L_{LDPC}) being a nominal codeword size. The set of systematic bits 412 may be the inputs into an encoder, such as the LDPC encoder 215 or the LDPC encoder 315 as illustrated by and described with reference to FIGS. 2 and 3. The set of parity bits 414 may be the outputs from the encoder, such as the LDPC encoder 215 or the LDPC encoder 315 as illustrated by and described with reference to FIGS. 2 and 3. Generally, systematic bits may include both data bits and shortening bits (if any). The codewords 410-a, 410-b, and 410-c may be associated with different types or versions of codewords. For example, the codewords 410-a, 410-b, and 410-c may illustrate more specific types of bits that may be more generally classified as the set of systematic bits 412 and the set of parity bits 414.

The codeword 410-a (which may be an example of a non-constellation shaped or normal LDPC codeword) illustrates an example in which a wireless communication device performs shortening and puncturing. For example, the codeword 410-a may include a set of data bits 416, a set of shortening bits 418, a set of parity bits 420, and a set of puncturing bits 422. Taken together, the set of data bits 416 and the set of shortening bits 418 may correspond to the set of systematic bits 412. The set of parity bits 420 may be an example of a set of unpunctured parity bits (of a larger set of parity bits, such as of the set of parity bits 414). For example, a wireless communication device may obtain the set of parity bits 420 by subtracting the set of puncturing bits 422 from the set of parity bits 414 (or, in other words, by puncturing a subset of the set of parity bits 414).

The codeword 410-b (which may be an example of a non-constellation shaped or normal LDPC codeword) illustrates an example in which a wireless communication device performs shortening and repetition. For example, the codeword 410-b may include a set of data bits 424, a set of shortening bits 426, a set of parity bits 428, and a set of repeated bits 430. Taken together, the set of data bits 424 and the set of shortening bits 426 may correspond to the set of systematic bits 412. The wireless communication device may obtain the set of parity bits 428 as an output of an LDPC encoder and may append the set of repeated bits 430 to (the end of) the codeword 410-b. The wireless communication device may select the set of repeated bits 430 from a beginning of the set of data bits 424.

The codeword 410-c (which may be an example of a constellation shaped LDPC codeword) illustrates an example in which a wireless communication device performs shortening and refrains from performing puncturing or repetition (such that the codeword 410-c includes zero punctured bits and zero repeated bits, such as no puncturing/repetition). For example, the codeword 410-c includes a set of data bits 432, a set of shortening bits 434, and a set of parity bits 436. Taken together, the set of data bits 432 and the set of shortening bits 434 may correspond to the set of systematic bits 412. The wireless communication device may obtain the set of parity bits 436 as an output of an LDPC encoder.

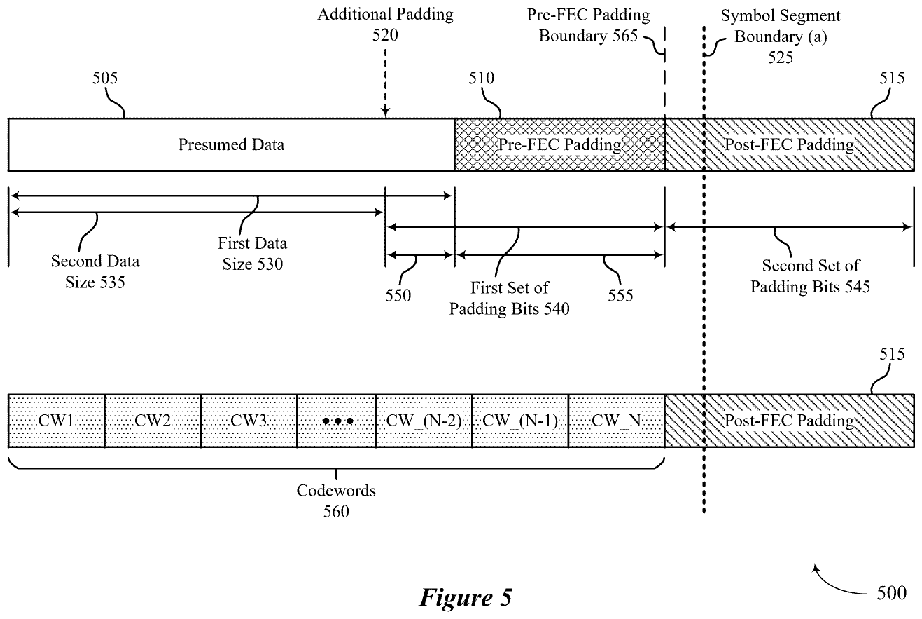

FIG. 5 shows an example rate matching scheme 500 that supports rate matching in combination with probability constellation shaping. For example, a wireless communication device (such as a transmitter or a receiver device) may employ at least some aspects of the rate matching scheme 500 to support LDPC rate matching in constellation shaping, such as to support rate matching in probability constellation shaping in Wi-Fi systems.

In some implementations, the wireless communication device may use a fixed amount of shortening, a fixed amount of puncturing, a fixed amount of repetition, or any combination thereof to facilitate LDPC rate matching in constellation shaping. Such fixed amounts may refer to any pre-defined, pre-configured, signaled, obtained, calculated, or retrieved numeric value that is, at least in some scenarios or for time intervals, static. A fixed amount may be zero, one, two, three, or any other numeric value. In some aspects, a quantity of PHY coded bits may be associated with (such as equal) an integer quantity of codewords 560 (such as LDPC codewords) multiplied by the constellation shaped codeword size L_{CS}. In some aspects, a pre-FEC padding boundary 565 and a PHY coded bits boundary may be the same. In other words, PHY coded bits may include a set of bits associated with presumed data 505 and a pre-FEC padding 510. In some implementations, the wireless communication device may use an N_{SYM} value (which may be indicative of a quantity of OFDM symbols within a data field of a packet to be transmitted) and a symbol segment factor a=aᵢₙᵢₜ in a last (final) OFDM symbol to determine the relevant boundaries, including one or both of the pre-FEC padding boundary 565 or a symbol segment boundary 525. The pre-FEC padding boundary 565 and the PHY coded bits boundary may be within the boundary determined by N_{SYM} and the symbol segment factor a and uniquely determined in accordance with these two values, and the constellation shaped codeword size L_{CS}.

In some aspects, the wireless communication device may include (if transmitting) or parse (if receiving) an indication of the symbol segment factor a=aᵢₙᵢₜ in or from a PHY preamble of the packet. In some systems, four pre-FEC padding boundaries partition the last OFDM symbol of a PPDU into four symbol segments. The pre-FEC padding 510 may pad toward one of the four possible boundaries. The four pre-FEC padding boundaries may be represented by the common pre-FEC padding factor (or, equivalently, the symbol segment factor) parameter a.

In some aspects, a quantity of the codewords 560 may be an upper limit quantity of codewords that fits up to the symbol segment boundary 525 (the symbol segment factor a in the last OFDM symbol). In some aspects, there may be some leftover bits (of post-FEC padding 515) within the boundary (such as within the symbol segment boundary 525). The post-FEC padding 515 may include or be referred to herein as a second set of padding bits 545 of post-FEC padding 515. The presumed data 505 may be associated with a first data size 530, which may be given by a MAC entity or layer of the wireless communication device as a presumed (such as estimated) PHY payload size after shaping N_{pld,shaped,u,estimated}. The MAC entity or layer may provide a margin within this size to fit in a set of shaped bits (after constellation shaping is applied to a set of information bits).

After shaping, if a quantity of the shaped bits is smaller than (less than) the first data size 530 associated with the presumed data 505, a PHY entity or layer of the wireless communication device may perform additional padding 520 (such as additional pre-FEC padding) to meet the first data size 530. For example, the PHY entity or layer may obtain a set of shaped information bits in association with applying a constellation shaping to a set of information bits and may determine, in accordance with performing the constellation shaping, that the set of shaped information bits are associated with a second data size 535, the second data size 535 being smaller than the first data size 530 signaled by the MAC entity or layer. In such scenarios, the PHY entity or layer may add one or more additional padding bits 550 to the set of shaped information bits to meet, satisfy, or reach the first data size 530 provided by the MAC entity or layer. In other words, the first data size 530 equals the second data size 535 plus a quantity of the one or more additional padding bits 550.

The wireless communication device may further include a set of padding bits 555 of pre-FEC padding 510 to fit to the determined (such as calculated or selected) quantity of codewords 560. In some aspects, the MAC entity or layer may pad to an upper limit quantity of octets and the PHY entity or layer may pad a remaining 0-7 bits. For example, the MAC entity or layer may provide the set of padding bits 555 of the pre-FEC padding 510 via one or more octets and the PHY entity or layer may selectively or conditionally perform additional padding within the pre-FEC padding 510 (such as to meet the pre-FEC padding boundary 565, if the set of padding bits 555 provided by the MAC entity or layer is insufficient to meet the pre-FEC padding boundary 565). Together, the one or more additional padding bits 550 and the set of padding bits 555 may correspond to a first set of padding bits 540, which may represent a total quantity of pre-FEC padding bits. In some aspects, the first set of padding bits 540 may be associated with the second data size 535 (and, more specifically, associated with a delta between the first data size 530 and the second data size 535) by way of including the one or more additional padding bits 550.

The wireless communication device may further perform post-FEC padding 515 after the end of the PHY coded bits boundary (such as the pre-FEC padding boundary 565) until an end of a last (final) OFDM symbol of a data field of the packet. For example, the wireless communication device may add at least the second set of padding bits 545 (to at least satisfy, equal, reach, or meet the symbol segment boundary 525, if not beyond). Generally, the second set of padding bits 545 spans an entirety of the post-FEC padding 515, as illustrated by FIG. 5, which may include a set of bits before the symbol segment boundary 525 or a set of bits after the symbol segment boundary 525, or both. In other words, the wireless communication device may perform post-FEC padding after the end of PHY coded bits boundary until the end of last OFDM symbol. Generally, a two-step padding process may be applied to a PPDU (such as a packet). A pre-FEC padding process including one or both of pre-FEC MAC and pre-FEC PHY padding may be applied before conducting or performing FEC coding, and a post-FEC PHY padding process may be applied on the FEC encoded bits.

In some implementations, the PHY entity or layer of the wireless communication device may exclusively perform the padding. In other words, the PHY entity or layer may perform the additional padding 520, the pre-FEC padding 510, and the post-FEC padding 515 without input from the MAC entity or layer. In such implementations, the MAC entity or layer may provide (such as transmit or send) the data for transmission to the PHY entity or layer. The PHY entity or layer may calculate, know, determine, or ascertain the first data size 530 of the presumed data 505. The PHY entity or layer may determine, calculate, or select the pre-FEC padding 510 (which, in some implementations, may be understood as including the one or more additional padding bits 550 and the set of padding bits 555) after applying a constellation shaping to the data and may perform the padding. The PHY entity or layer also may add the second set of padding bits 545 associated with the post-FEC padding 515.

Additionally, or alternatively, both the MAC and the PHY entities or layers may perform the padding. In some implementations, the MAC entity or layer may provide the data for transmission before constellation shaping and may provide a sufficiently long pre-FEC padding 510 (such as a pre-FEC padding 510 that at least extends to the pre-FEC padding boundary 565, if not beyond to provide a margin). In such implementations, the PHY entity or layer may perform the shaping and may stop (such as terminate) the shaping at the pre-FEC padding boundary 565. In examples in which the MAC entity or layer provides the pre-FEC padding 510 with an additional margin beyond the pre-FEC padding boundary 565, the pre-FEC padding boundary 565 may separate out the extra pre-FEC padding bits provided by the MAC entity or layer.

In some other implementations, the MAC entity or layer may provide the data for transmission before shaping and the pre-FEC padding 510 (such as at least a subset of the set of padding bits 555, in octets) to the PHY entity or layer. The PHY entity or layer may likewise know both the first data size 530 associated with the presumed data 505 and the size of the pre-FEC padding 510 provided by the MAC entity or layer. The PHY entity or layer may determine, calculate, or select an additional pre-FEC padding size (such as the one or more additional padding bits 550 of the additional padding 520) after applying the constellation shaping and may add the one or more additional padding bits 550. The PHY entity or layer may, additionally, add an addition 0-7 bits to the pre-FEC padding 510 provided by the MAC entity or layer. For example, the MAC entity or layer may provide a subset of the set of padding bits 555 (in octets) and the PHY entity or layer may add an addition 0-7 bits to meet the pre-FEC padding boundary 565 (such that both the MAC and the PHY entities or layers may contribute padding bits to the set of padding bits 555).

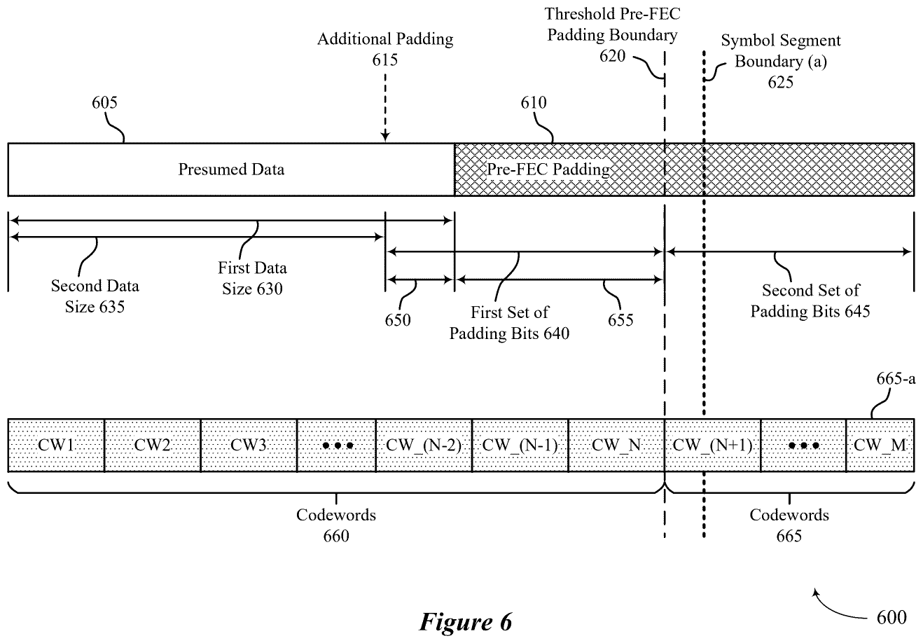

In some aspects, a content of the pre-FEC padding 510 (which may include the set of padding bits 555, or both the one or more additional padding bits 550 and the set of padding bits 555) may include unshaped random bits. In some aspects, a padding bit stream (before shaping and LDPC encoding), such as the pre-FEC padding 510, may be chosen to be bits that could generate shaped bits that could be mapped to QAM symbols with relatively smaller powers (such as less than a threshold power). Additionally, or alternatively, the content of the pre-FEC padding 510 (which may include the set of padding bits 555, or both the one or more additional padding bits 550 and the set of padding bits 555) may include bits taken (such as selected) from a (known or unknown) sequence of a shaped bit stream. Additionally, or alternatively, the content of the pre-FEC padding 510 (which may include the set of padding bits 555, or both the one or more additional padding bits 550 and the set of padding bits 555) may include shaped bits from a shaped bit stream which is the output of the pre-FEC padding through a shaper. Further, a content of the post-FEC padding 515 (such as the second set of padding bits 545) may include one or more codewords 560 (such as LDPC codewords) generated in accordance with an extra pre-FEC padding provided by the MAC entity or layer. The wireless communication device may put such extra pre-FEC padding through a shaper or may refrain from putting such extra pre-FEC padding through a shaper (such that, when used as post-FEC padding 515, the extra pre-FEC padding provided by the MAC entity or layer may be shaped or unshaped). In this case (which is illustrated by and described in further detail with reference to FIG. 6), it may be considered as the pre-FEC padding boundary being extended to the end of the last OFDM symbol in the data field of the packet, such that there is no post-FEC padding, as (essentially all) padding comes from one or more codewords (such as LDPC codewords) generated in accordance with pre-FEC padding through a shaper. Even so, a critical (such as threshold) pre-FEC padding boundary may be denoted by (N_{SYM}, a), because it may be associated with the minimum (such as lower limit) pre-FEC padding expected to transmit the information bits (such as all shaped information bits), and the minimum (such as lower limit) number of PHY coded bits a receiving device may expect to process to obtain the information bits (such as all shaped information bits). In some aspects, the last codeword may be of a smaller size compared to other codewords so as to fit into the OFDM symbol boundary. The last codeword may use different quantities of shortening bits, punctured bits, or repeated bits to still keep or maintain the quantity of data bits and the summation of quantity of unpunctured bits and quantity of repeated bits to be proportional to the quantities of amplitude bits and sign bits, respectively. Additionally, or alternatively, the content of the post-FEC padding 515 (such as the second set of padding bits 545) may include one or more random (or pseudorandom) bits.

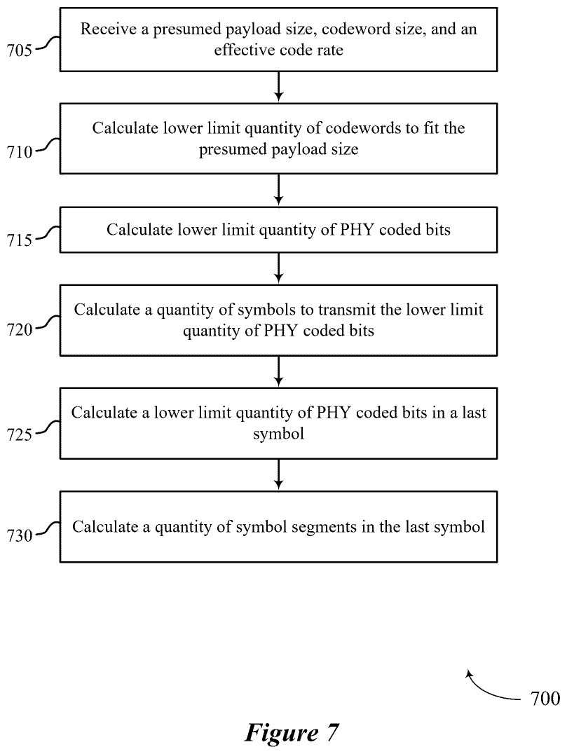

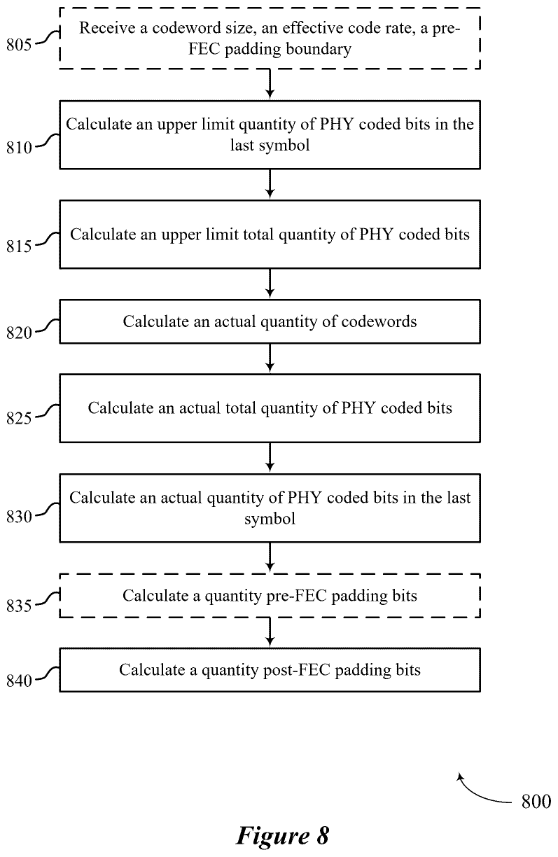

The wireless communication device may use, employ, activate, or leverage an algorithm (such as a rate matching algorithm) to determine an LDPC codeword size, a quantity of LDPC codewords, and a quantity of pre-FEC padding bits. In some implementations, the wireless communication device may use such an algorithm in accordance with performing rate matching and constellation shaping. In some implementations, a transmitter device and a receiver device may use different algorithms. For example, a transmitter device may use a first algorithm and a receiver device may use a second algorithm. Additional details relating to such algorithms are further illustrated by and described with reference to FIGS. 7 and 8.

FIG. 6 shows an example rate matching scheme 600 that supports rate matching in combination with probability constellation shaping. For example, a wireless communication device (such as a transmitter or a receiver device) may employ at least some aspects of the rate matching scheme 600 to support LDPC rate matching in constellation shaping, such as to support rate matching in probability constellation shaping in Wi-Fi systems.

In some examples, the wireless communication device may use, employ, or leverage the rate matching scheme 600 in implementations in which the pre-FEC padding boundary is extended to the end of the last OFDM symbol, such that there is no or relatively less post-FEC padding, as (essentially all) padding comes from one or more codewords (such as LDPC codewords) generated in accordance with pre-FEC padding 610 through a shaper. For example, a MAC entity or layer may provide enough (such as extra) pre-FEC padding 610 such that the PHY entity or layer may refrain from using or adding post-FEC padding or such that the PHY entity or layer may use a relatively small amount of post-FEC padding (such as less than the post-FEC padding 515 as illustrated by and described with reference to FIG. 5, or otherwise less than a threshold amount of post-FEC padding). Instead, the wireless communication device may use one or more codewords 665 (such as LDPC codewords) generated in accordance with “extra” pre-FEC padding 610 as padding in the rate matching process. The wireless communication device may put such “extra” pre-FEC padding through a shaper or may refrain from putting such “extra” pre-FEC padding through a shaper (such that the extra pre-FEC padding provided by the MAC entity or layer may be shaped or unshaped).

In accordance with some implementations, “extra pre-FEC padding” may be understood as a portion of the pre-FEC padding 610 beyond a threshold pre-FEC padding boundary 620, which may be equivalently referred to herein as a critical pre-FEC padding boundary. For example, such “extra pre-FEC padding” may be understood as, include, or refer to a second set of padding bits 645. Such a threshold pre-FEC padding boundary 620 may be denoted by (N_{SYM}, a) and may be associated with a lower limit pre-FEC padding expected to be used to transmit the information bits (such as all shaped information bits) and a lower limit quantity of PHY coded bits a receiving device may expect to use to process to obtain the information bits (such as all shaped information bits). In some implementations, the wireless communication device may use the N_{SYM} value (which may be indicative of a quantity of OFDM symbols within a data field of a packet to be transmitted) and the symbol segment factor a=@init in a last (final) OFDM symbol to determine the relevant boundaries, including one or both of the threshold pre-FEC padding boundary 620 or a symbol segment boundary 625.

The codewords 665 may be examples of codewords generated using extra pre-FEC padding 610, such as pre-FEC padding 610 beyond the threshold pre-FEC padding boundary 620. In other words, the codewords 665 may be associated with the second set of padding bits 645. In some aspects, a last codeword 665-a may be of a smaller size compared to other codewords 665 so as to fit into an OFDM symbol boundary. For example, a first set of codewords 665 may be a first size and the last codeword 665-a may be a second size, the second size smaller than the first size. Further, the last codeword 665-a may use different quantities of shortening bits, punctured bits, or repeated bits to keep or maintain the quantity of data bits and the summation of quantity of unpunctured (parity) bits and quantity of repeated bits as being proportional to the quantities of amplitude bits and sign bits, respectively.

In accordance with the rate matching scheme 600, the wireless communication device may obtain information indicative of presumed data 605 or a first data size 630 associated with the presumed data 605, may obtain an indication of a second data size 635 in association with applying a constellation shaping to a set of information bits, and, if the second data size 635 is smaller than the first data size 630, may perform additional padding 615 by adding one or more additional padding bits 650 (such as one or more additional pre-FEC padding bits). The wireless communication device may select, obtain, receive, or determine the pre-FEC padding 610 (as, for example, provided by a MAC entity or layer) and may generate one or more codewords 660 in association with performing an error correction encoding (such as FEC or LDPC encoding) associated with shaped information bits and at least a portion of the pre-FEC padding 610.

In some aspects, the portion of the pre-FEC padding 610 may include a set of padding bits 655 in addition to, if present, the one or more additional padding bits 650. Collectively, the set of padding bits 655 and the one or more additional padding bits 650 may be referred to as a first set of padding bits 640. The wireless communication device also may generate one or more codewords 665 in association with performing an error correction encoding (such as FEC or LDPC encoding) associated with the shaped information bits and the extra pre-FEC padding 610 (such as the second set of padding bits 645). In some examples, the wireless communication device may use such one or more codewords 665 instead of a post-FEC padding as part of transmitting a packet including the shaped information bits.

In some implementations, a MAC entity or layer may pass a set of information bits (such as an information bitstream) along with enough padding bits (such as a long enough, or sufficiently long, padding bitstream to a PHY entity or layer and the PHY entity or layer may perform shaping and LDPC encoding on the information bitstream and long enough padding bitstream to fill up to a last OFDM symbol of a data field of a packet. In such implementations, the PHY entity or layer may terminate shaping and the LDPC encoding process at a point at which there are enough coded bits to fill up the last OFDM symbol of the data field (along with a remainder of the OFDM symbols of the data field). In some examples, the MAC entity or layer may provide extra margin in the provided long enough padding bitstream, such that there may be one or multiple bits left in the long enough padding bitstream at a point (such as a boundary) at which the PHY entity or layer terminates the shaping and the LDPC encoding process. Thus, in such implementations, the MAC entity or layer may generate/provide the padding bits and the PHY entity or layer may refrain from generating/providing padding bits. Instead, the PHY entity or layer may pass the padding bits through the shaper and the LDPC encoder to generate coded bits and may map the coded bits to one or more QAM symbols in the last OFDM symbol (among other OFDM symbols in the data field of the packet).

FIG. 7 shows an example rate matching algorithm 700 that supports rate matching in combination with probability constellation shaping and that is implementable at a transmitter device. A wireless communication device (such as a transmitter device) may employ the rate matching algorithm 700 to support LDPC rate matching in constellation shaping, such as to support rate matching in probability constellation shaping in Wi-Fi systems. Alternative examples of the following may be implemented. Some steps are performed in a different order than described or are not performed at all. In some implementations, steps may include additional features not mentioned below, or further steps may be added.

At 705, the wireless communication device may receive (or otherwise obtain) a presumed payload size after shaping N_{pld,shaped,u,estimated}, a constellation shaped LDPC codeword size L_{CS,u} and an effective code rate R_{eff,u} (for user u). For example, at a transmitter device, for user u, the transmitter device may leverage at least the rate matching algorithm 700 (and also, in some examples, the rate matching algorithm 800) to determine the pre-FEC padding boundary denoted by (N_{SYM}, a), the pre-FEC padding size, the quantity of codewords N_{CW,u}, and the post-FEC padding size given the presumed payload size after shaping N_{pld,shaped,u,estimated}, the constellation shaped LDPC codeword size L_{CS,u} and the effective code rate R_{eff,u}.

At 710, the wireless communication device may calculate a lower limit quantity of codewords to fit the presumed payload size. In other words, the wireless communication device may calculate the minimum number of LDPC codewords for user u to fit in all N_{pld,shaped,u,estimated} information bits. Such a lower limit quantity of codewords may be denoted as N_{CW,u,min} (or, more generally, N_{CW,min}) and calculated in accordance with:

$${N}_{CW , u , min} = ⌈ \frac{{N}_{pld , shaped , u , estimated}}{{L}_{CS , u} \cdot {R}_{eff , u}} ⌉$$

At 715, the wireless communication device may calculate a lower limit quantity of PHY coded bits. In other words, the wireless communication device may calculate the minimum number of PHY coded bits for user u. Such a lower limit quantity of PHY coded bits may be denoted as N_{avbits,u,min} (or, more generally, N_{avbits,min}) and calculated in accordance with:

$${N}_{avbits , u , min} = {N}_{CW , u , min} \cdot {L}_{CS , u}$$

At 720, the wireless communication device may calculate a quantity of symbols to transmit the lower limit quantity of PHY coded bits (such as a quantity of symbols within a data field of the packet to be transmitted). In other words, the wireless communication device may determine the number of OFDM symbols for user u to transmit N_{avbits,u,min} PHY coded bits. Such a quantity of symbols may be denoted as N_{SYM,u} (or, more generally, N_{SYM}) and may be calculated in accordance with:

$${N}_{SYM , u} = ⌈ \frac{{N}_{avbits , u , min}}{{N}_{CBPS , u}} ⌉$$

At 725, the wireless communication device may calculate a lower limit quantity of PHY coded bits in a last symbol of the data field. In other words, the wireless communication device may calculate the minimum number of PHY coded bits left in the last OFDM symbol for user u. Such a lower limit quantity of PHY coded bits in a last symbol of the data field may be denoted as N_{CBPS,last,u,min} (or, more generally, N_{CBPS,last,min}) and may be calculated in accordance with:

$${N}_{CBPS , last , u , min} = {N}_{avbits , u , min} mod {N}_{CBPS , u}$$

At 730, the wireless communication device may calculate a quantity of symbol segments in the last symbol. In other words, the wireless communication device may determine the number of symbol segment for user u. Such a quantity of symbol segments in the last symbol may be denoted as aᵤ (or, more generally, a) and may be calculated in accordance with:

$${a}_{u} = \{ \begin{matrix}4 , & if {N}_{CBPS , last , u , min} = 0 \\ min ( ⌈ \frac{{N}_{CBPS , last , u , min}}{{N}_{CBPS , short , u}} ⌉ , 4 ) , & otherwise\end{matrix}$$

In accordance with the rate matching algorithm 700, the wireless communication device may determine, among other variables or parameters, the pre-FEC padding boundary denoted by (N_{SYM}, a). In some implementations, the wireless communication device may further perform the rate matching algorithm 800, as illustrated by and described with reference to FIG. 8, to determine one or more other variables or parameters, such as the pre-FEC padding size, the quantity of codewords N_{CW,u}, and the post-FEC padding size.

FIG. 8 shows an example rate matching algorithm 800 that supports rate matching in combination with probability constellation shaping and that is implementable at one or both of a transmitter device or a receiver device. A wireless communication device (such as a transmitter or a receiver device) may employ the rate matching algorithm 800 to support LDPC rate matching in constellation shaping, such as to support rate matching in probability constellation shaping in Wi-Fi systems. Alternative examples of the following may be implemented. Some steps are performed in a different order than described or are not performed at all. In some implementations, steps may include additional features not mentioned below, or further steps may be added.

At 805, the wireless communication device may receive (or otherwise obtain) a codeword size, an effective code rate, and a pre-FEC padding boundary. In other words, the wireless communication device receive or obtain the constellation shaped LDPC codeword size L_{CS,u} and R_{eff,u} and common pre-FEC padding boundary denoted by (N_{SYM}, a) or user specific pre-FEC padding boundary (N_{SYM,u}, aᵤ). For example, for user u, the wireless communication device may determine the number of codewords N_{CW,u} and post-FEC padding size, given (such as in association with obtaining information indicative of) the constellation shaped LDPC codeword size L_{CS,u} and R_{eff,u} and common pre-FEC padding boundary denoted by (N_{SYM}, a) or user specific pre-FEC padding boundary denoted by (N_{SYM,u}, aᵤ) (if the wireless communication device is a receiver device). A receiver device may decode, parse, obtain, and/or extract information (such as a set of information bits) from a packet in association with determining the number of codewords N_{CW,u} and post-FEC padding size.

In some implementations, such as implementations in which the wireless communication device is a transmitter device, the wireless communication device may receive or obtain at least a portion of such information in accordance with performing the rate matching algorithm 700. In some other implementations, such as in implementations in which the wireless communication device is a receiver device, the wireless communication device may receive or obtain at least a portion of such information via signaling (such as via one or more bits or fields of a preamble or a data portion of a packet or otherwise in accordance with parsing a received packet), in accordance with one or more rules or calculations, or in accordance with a retrieval from one or more memories.

At 810, the wireless communication device may calculate an upper limit quantity of PHY coded bits in a last symbol of a data field of a packet to be transmitted (or of a received packet). In other words, the wireless communication device may calculate the maximum number of PHY coded bits left in the last OFDM symbol for user u based on the symbol segment boundary. Such an upper limit quantity of PHY coded bits in the last symbol may be denoted as N_{CBPS,last,u} (or, more generally, N_{CBPS,last}) and may be calculated in accordance with:

$${N}_{CBPS , last , u} = \{ \begin{matrix}{a}_{u} \cdot {N}_{CBPS , short , u} & if {a}_{u} < 4 \\ {N}_{CBPS , u} & if {a}_{u} = 4\end{matrix}$$

At 815, the wireless communication device may calculate an upper limit total quantity of PHY coded bits. In other words, the wireless communication device may calculate the maximum number of PHY coded bits for user u based on the symbol segment boundary. Such an upper limit total quantity of PHY coded bits may be denoted as N_{avbits,u,max} (or, more generally, N_{avbits, max}) and may be calculated in accordance with:

$${N}_{avbits , u , max} = ( {N}_{SYM , u} - 1 ) {N}_{CBPS , u} + {N}_{CBPS , last , u}$$

At 820, the wireless communication device may calculate an actual quantity of codewords. In other words, the wireless communication device may calculate the final number of LDPC codewords for user u. Such an actual quantity of codewords may be denoted as N_{CW,u} (or, more generally, N_{CW}) and may be calculated in accordance with:

$${N}_{CW , u} = ⌊ \frac{{N}_{avbits , u , max}}{{L}_{CS , u}} ⌋$$

At 825, the wireless communication device may calculate an actual total quantity of PHY coded bits associated with the data field of the packet. In other words, the wireless communication device may calculate the final number of PHY coded bits for user u. Such an actual total quantity of PHY coded bits may be denoted as N_{avbits,u} (or, more generally, N_{avbits}) and may be calculated in accordance with:

$${N}_{avbits , u} = {N}_{CW , u} \cdot {L}_{CS , u}$$

At 830, the wireless communication device may calculate an actual quantity of PHY coded bits in the last symbol of the data field. In other words, the wireless communication device may calculate the final number of PHY coded bits in the last OFDM symbol of user u. Such an actual quantity of PHY coded bits in the last symbol may be denoted as N_{CBPS,last,u} (or, more generally, N_{CBPS,last}) and may be calculated in accordance with:

$${N}_{CBPS , last , u} = {N}_{avbits , u} mod {N}_{CBPS , u}$$

At 835, the wireless communication device may calculate a quantity of pre-FEC padding bits. In other words, the wireless communication device may calculate the number of pre-FEC padding bits according to the LDPC codeword size and the number of codewords. In some aspects, if the wireless communication device is a receiver device, the wireless communication device may skip the calculation of the quantity of pre-FEC padding bits. Such a quantity of pre-FEC padding bits may be denoted as N_{PAD,Pre-FEC,u} (or, more generally, N_{PAD,Pre-FEC}) and may be calculated in accordance with:

$${N}_{PAD , Pτe - FEC , u} = {N}_{CW , u} \cdot {L}_{CS , u} \cdot {R}_{eff , u} - {N}_{pld , shaped , u , estimated}$$

In some aspects, the quantity of pre-FEC padding bits may correspond to the set of padding bits 555 or the set of padding bits 655 and may not include possible additional pre-FEC padding bits to fill up to the presumed data size (such as the first data size 530 or the first data size 630), if the quantity of shaped its after shaping is less than the presumed data size. In other words, the quantity of pre-FEC padding bits calculated at 835 may exclude or not account for the one or more additional padding bits 550 or the one or more additional padding bits 650.

At 840, the wireless communication device may calculate a quantity of post-FEC padding bits. The quantity of post-FEC padding bits may be denoted as N_{PAD,Post-FEC,u} (or, more generally, N_{PAD,Post-FEC}). The quantity of post-FEC padding bits may correspond to the second set of padding bits 545 (such as the post-FEC padding 515). In some examples, the wireless communication device may calculate the number of post-FEC padding bits according to the unoccupied bits as determined by:

$${N}_{PAD , Post - FEC , u} = {N}_{CBPS , u} - {N}_{CBPS , last , u}$$

In some aspects, if there is more than one user (N_{user,total}>1), the last OFDM symbol in Data field N_{SYM} may be determined in accordance with the largest N_{SYM,u} and the common pre-FEC padding boundary a value may be determined in accordance with the largest ay value among all users. Some users may have pre-FEC or post-FEC padding to match N_{SYM} if N_{SYM}>N_{SYM,u}. In some implementations, a packet extension duration may be determined in accordance with a largest

$$( {N}_{SYM , u} - 1 + \frac{{a}_{u}}{4} )$$

among all users.

In examples in which the wireless communication device is a transmitter device, the wireless communication device may generate one or more codewords in accordance with the rate matching (for constellation shaping) and transmit a packet including the one or more codewords accordingly. In a PHY preamble of the packet (a PPDU), if both the transmitter and the receiver know that probability constellation shaping is used, the transmitter device may signal the symbol segment factor a value. In some aspects, because the common pre-FEC padding factor a is signaled in the PHY preamble, this value may be interpreted as the symbol segment factor a value in scenarios of probability constellation shaping. Additionally, or alternatively, in a user info field in a PHY preamble, the transmitter device also may signal the quantity of OFDM symbols N_{SYM,u} or a quantity of symbol segments aᵤ to determine the pre-FEC padding boundary and PHY coded bits boundary for user u.

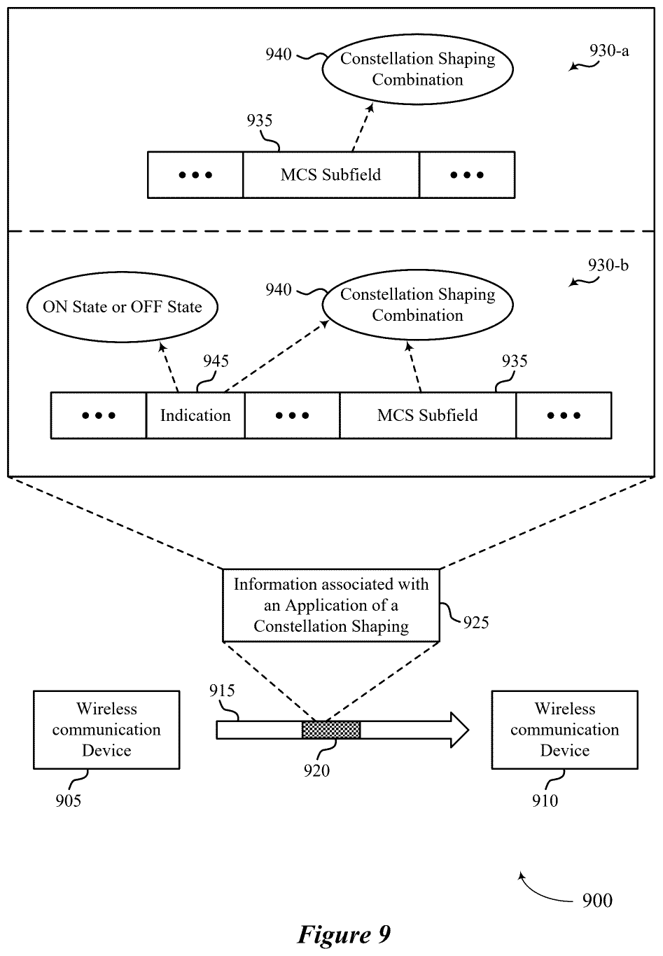

FIG. 9 shows an example signaling diagram 900 that illustrates how various wireless communication devices may provide information associated with an application of a probability constellation shaping. The signaling diagram 900 illustrates communication between a wireless communication device 905 and a wireless communication device 910, each of which may be an example of the wireless communication devices described herein. In some aspects, the wireless communication device 905 may be a transmitter device and the wireless communication device 910 may be a receiver device. The wireless communication device 905 and the wireless communication device 910 may communicate via a communication link 915.

In some implementations, the wireless communication device 905 and the wireless communication device 910 may support a signaling mechanism or design associated with an application of a constellation shaping to a set of information bits. For example, the wireless communication device 905 and the wireless communication device 910 may exchange (such as transmit or receive, or both), via a frame 920, information 925 indicative of whether constellation shaping is used or activated or information 925 indicative of one or more parameters associated with constellation shaping, or both. The frame 920 may be a beacon frame, an association frame, an authentication frame, a probing request frame, a probing response frame, a trigger frame, or any other frame type.

The wireless communication device 905 may convey or transmit the information 925 (and, likewise, the wireless communication device 910 may parse or receive the information 925) in accordance with a format 930-a or a format 930-b. In accordance with the format 930-a, the wireless communication device 905 and the wireless communication device 910 may treat or use constellation shaping combinations 940 as new MCS values. For example, in some systems, an MCS subfield 935 may include at least five bits to uniquely convey a set of MCSs. In some aspects, the set of MCSs may correspond to a subset of a possible set of codepoints associated with the five bits. For example, the set of MCSs may include 20 MCSs, which may leave 12 different codepoints associated with the MCS subfield 935 unused (as a set of five bits may be associated with 32 unique codepoints).

Accordingly, in some implementations, a first subset of codepoints associated with the MCS subfield 935 may correspond to the set of MCSs and a second subset of codepoints associated with the MCS subfield 935 may correspond to a set of constellation shaping combinations 940. In other words, each codepoint of the first subset of codepoints may correspond to (such as point to or indicate) a respective MCS from the set of MCSs and each codepoint of the second subset of codepoints may correspond to (such as point to or indicate) a respective constellation shaping combination 940 from the set of constellation shaping combinations 940. For example, a first codepoint may correspond to a first MCS, a second codepoint may correspond to a second MCS, a third codepoint may correspond to a first constellation shaping combination 940, and a fourth codepoint may correspond to a second constellation shaping combination 940.

The wireless communication device 905 may indicate a constellation shaping combination 940 via the MCS subfield 935 in accordance with setting the MCS subfield 935 to a codepoint of the second subset of codepoints. The second subset of codepoints may include a quantity of codepoints in a range of, for example, 1-12 (inclusive). The wireless communication device 905 and the wireless communication device 910 may support one or more interpretation rules associated with using an MCS subfield 935 and/or a subfield that includes information associated with an equal/unequal modulation pattern to provide an indication of a constellation shaping combination 940. A constellation shaping combination 940 may refer to a specific set of a shaper rate, a modulation scheme or a pattern of modulation schemes (if indicated in a subfield that includes information associated with an equal/unequal modulation pattern), and an FEC code rate. For example, each constellation shaping combination 940 of a set of constellation shaping combinations 940 may be associated with a respective shaper rate, a respective modulation scheme or a respective pattern of modulation schemes, and a respective FEC code rate.

In accordance with the format 930-b, the wireless communication device 905 and the wireless communication device 910 may use a separate indication 945 to signal whether constellation shaping is set to an ON state or an OFF state (such as to indicate whether constellation shaping is used, or to be used, or not). In some implementations, the wireless communication device 905 may include the indication 945 in a preamble of the frame 920 or in a preamble of a packet (a PPDU) carrying the frame 920. In some implementations, the indication 945, which may be a 1-bit indicator or a multi-bit indicator, and an MCS subfield 935 may jointly signal (such as indicate) a constellation shaping combination 940. For example, a codepoint associated with a combination of two or more of the indication 945, the MCS subfield 935, and a subfield that includes information associated with an equal/unequal modulation pattern may correspond to a constellation shaping combination 940. In such examples, the MCS subfield 935 may include four bits or may include at least five bits. In examples in which the MCS subfield 935 includes four bits, the information 925 may effectively be associated with at least five bits in accordance with jointly using the indication 945, the MCS subfield 935, and/or a subfield that includes information associated with an equal/unequal modulation pattern to indicate a constellation shaping combination 940.

In some PPDUs, such as UHR MU PPDUs, the wireless communication device 905 may include the indication 945 in a common field, such as a common info field. In such examples, the wireless communication device 905 may set constellation shaping to an ON state or an OFF state for a set of users (such as for all users) that receive the frame 920. Additionally, or alternatively, in some PPDUs, such as UHR MU PPDUs, the wireless communication device 905 may include the indication 945 in one or both of non-MU-MIMO and MU-MIMO user info field formats. In such examples, the wireless communication device 905 may set constellation shaping to an ON state or an OFF state for different users (such as on a per-user basis). For example, the wireless communication device 905 may include a first indication 945 in a first user info field and may include a second indication 945 in a second user info field, with the first indication 945 and the second indication 945 being the same or different. The first indication 945 may indicate that constellation shaping is ON or OFF for a first wireless communication device associated with (identified by) the first user info field and the second indication 945 may indicate that constellation shaping is ON or OFF for a second wireless communication device associated with (identified by) the second user info field.

Further, for some PPDUs, such as for a UHR trigger based (TB) PPDU, the wireless communication device 905 may include the indication 945 in a UHR variant user info field in a Trigger Frame. Additionally, or alternatively, the wireless communication device 905 and the wireless communication device 910 may support an interpretation rule or mechanism associated with some other field types, such as for EHT variant user info fields, to repurpose one or both of a reserved bit (such as B25) and 1 bit in a starting spatial stream subfield within a spatial stream (SS) allocation subfield to provide the indication 945, or to provide other information associated with communication between the wireless communication device 905 and the wireless communication device 910. For example, the wireless communication device 905 and the wireless communication device 910 may use such bits to indicate an MCS or information associated with an MCS, a constellation shaping or information associated with a constellation shaping, 2×LDPC or information associated with 2×LDPC, or a global cyclic shift diversity (CSD) (for distributed resource unit (dRU)) or information associated with global CSD, among other information.

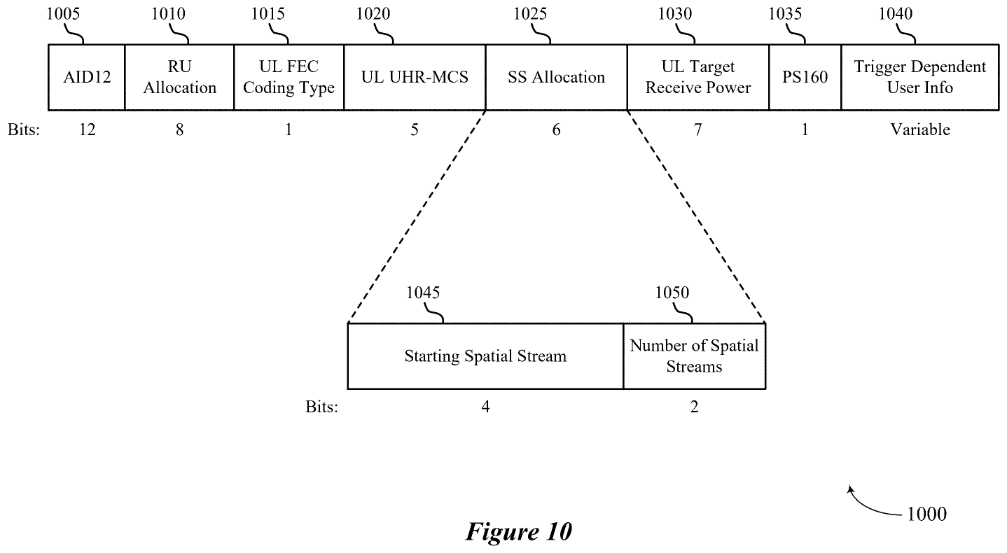

FIG. 10 shows an example user info field format 1000 that a wireless communication device may use to signal information associated with an application of a probability constellation shaping. A wireless communication device, such as the wireless communication device 905 or the wireless communication device 910 as illustrated by and described with reference to FIG. 9, may use the user info field format 1000, which may be associated with a UHR variant user info field, to convey information associated with an application of a constellation shaping.

The user info field format 1000, which may be included in a Trigger Frame, may include an AID 12 subfield 1005, an RU allocation subfield 1010, an uplink FEC coding type subfield 1015, an uplink UHR-MCS subfield 1020 (which may include 5 bits), an SS allocation subfield 1025, an uplink target receive power subfield 1030, a PS160 subfield 1035 (which may indicate a primary 160 MHz channel or a secondary 160 MHz channel that the RU or MRU allocation applies to if the size of the RU or the MRU is smaller than or equal to 2×996 tones; otherwise, the PS160 subfield 1035 may be used to indicate the RU or MRU index along with the RU allocation subfield 1010), and a trigger dependent user info subfield 1040. The SS allocation subfield 1025 may include a starting spatial stream subfield 1045 and a number of spatial streams (N_{SS}) subfield 1050. In some systems (such as UHR systems), a PHY version identifier subfield in a special user info field may be set to a value to indicate UHR. In some aspects, a value of the AID 12 subfield 1005 may indicate that the user info field format 1000 is associated with an EHT variant user info field (even though a UHR user info field is illustrated in the example of the user info field format 1000). In examples in which an EHT variant user info field is used, an MCS subfield (such as an uplink EHT-MCS subfield) may include 4 bits and the user info field may further include a reserved bit. In some systems, the SS allocation subfield 1025 may lack an indication of a non-MU-MIMO allocation or an MU-MIMO allocation.

In some implementations, the wireless communication device may support an interpretation rule or mechanism to repurpose one or both of a reserved bit (such as B 25) (if, for example, an EHT variant user info field is used) and 1 bit in a starting spatial stream subfield 1045 within the SS allocation subfield 1025 to provide the indication 945, or to provide other information associated with communication to or from the wireless communication device. For example, the wireless communication device may use such bits to indicate an MCS or information associated with an MCS, a constellation shaping or information associated with a constellation shaping, 2×LDPC or information associated with 2×LDPC, or a global CSD (for dRU) or information associated with global CSD, among other information.

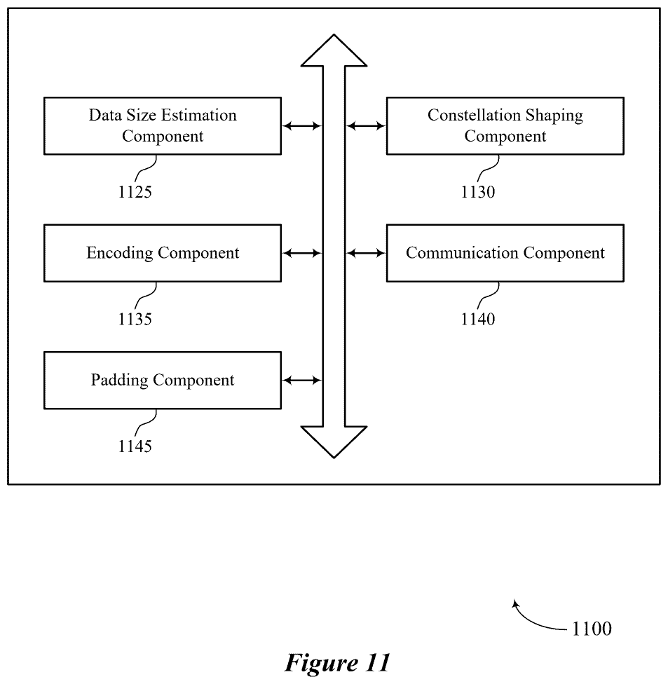

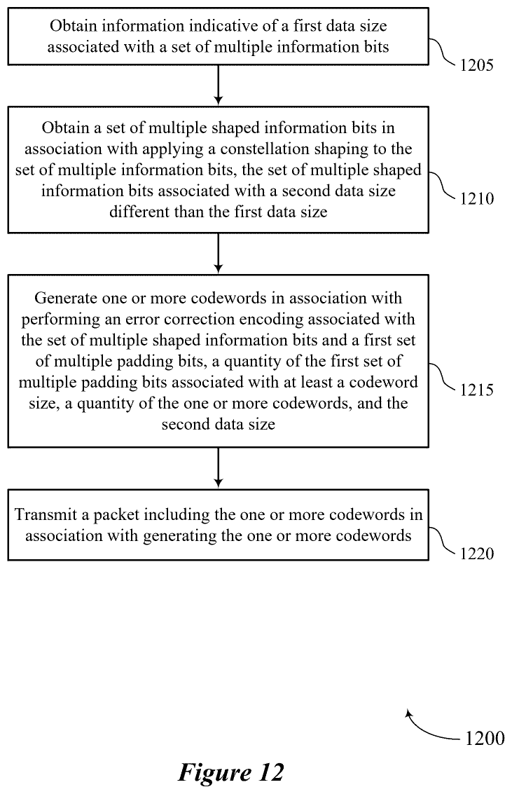

FIG. 11 shows a block diagram of an example wireless communication device 1100 that supports rate matching and signaling in probability constellation shaping in Wi-Fi systems. In some examples, the wireless communication device 1100 is configured to perform the processes 1200, 1300, and 1400 described with reference to FIGS. 12, 13, and 14, respectively. The wireless communication device 1100 may include one or more chips, SoCs, chipsets, packages, components or devices that individually or collectively constitute or include a processing system. The processing system may interface with other components of the wireless communication device 1100, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1100 may transmit the information output from the chip. In such an example, the second interface may refer to an interface between the processing system of the chip and a reception component, such that the wireless communication device 1100 may receive information that is then passed to the processing system. In some such examples, the first interface also may obtain information, such as from the transmission component, and the second interface also may output information, such as to the reception component.

The processing system of the wireless communication device 1100 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGA s)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”).

One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. In some implementations, one or more of the multiple memories may be configured to store processor-executable code that, when executed, may configure one or more of the multiple processors to perform various functions described herein (as part of a processing system). In some other implementations, the processing system may be pre-configured to perform various functions described herein.

The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1100 can be configurable or configured for use in an AP or STA, such as the AP 102 or the STA 104 described with reference to FIG. 1. In some other examples, the wireless communication device 1100 can be an AP or STA that includes such a processing system and other components including multiple antennas. The wireless communication device 1100 is capable of transmitting and receiving wireless communications in the form of, for example, wireless packets. For example, the wireless communication device 1100 can be configurable or configured to transmit and receive packets in the form of physical layer PPDUs and M PDUs conforming to one or more of the IEEE 802.11 family of wireless communication protocol standards. In some other examples, the wireless communication device 1100 can be configurable or configured to transmit and receive signals and communications conforming to one or more 3GPP specifications including those for 5G NR or 6G. In some examples, the wireless communication device 1100 also includes or can be coupled with one or more application processors which may be further coupled with one or more other memories. In some examples, the wireless communication device 1100 further includes a user interface (UI) (such as a touchscreen or keypad) and a display, which may be integrated with the UI to form a touchscreen display that is coupled with the processing system. In some examples, the wireless communication device 1100 may further include one or more sensors such as, for example, one or more inertial sensors, accelerometers, temperature sensors, pressure sensors, or altitude sensors, that are coupled with the processing system. In some examples, the wireless communication device 1100 further includes at least one external network interface coupled with the processing system that enables communication with a core network or backhaul network that enables the wireless communication device 1100 to gain access to external networks including the Internet.

The wireless communication device 1100 includes a data size estimation component 1125, a constellation shaping component 1130, an encoding component 1135, a communication component 1140, and a padding component 1145. Portions of one or more of the data size estimation component 1125, the constellation shaping component 1130, the encoding component 1135, the communication component 1140, and the padding component 1145 may be implemented at least in part in hardware or firmware. For example, one or more of the data size estimation component 1125, the constellation shaping component 1130, the encoding component 1135, the communication component 1140, and the padding component 1145 may be implemented at least in part by at least a processor or a modem. In some examples, portions of one or more of the data size estimation component 1125, the constellation shaping component 1130, the encoding component 1135, the communication component 1140, and the padding component 1145 may be implemented at least in part by a processor and software in the form of processor-executable code stored in memory.

The wireless communication device 1100 may support wireless communication in accordance with examples as disclosed herein. The data size estimation component 1125 is configurable or configured to obtain information indicative of a first data size associated with a set of multiple information bits. The constellation shaping component 1130 is configurable or configured to obtain a set of multiple shaped information bits in association with applying a constellation shaping to the set of multiple information bits, the set of multiple shaped information bits associated with a second data size different than the first data size. The encoding component 1135 is configurable or configured to generate one or more codewords in association with performing an error correction encoding associated with the set of multiple shaped information bits and a first set of multiple padding bits, a quantity of the first set of multiple padding bits associated with at least a codeword size, a quantity of the one or more codewords, and the second data size. The communication component 1140 is configurable or configured to transmit a packet including the one or more codewords in association with generating the one or more codewords.

In some examples, the quantity of the first set of multiple padding bits is at least associated with a difference between a first value and a second value. In some examples, the first value is equal to a product of the quantity of the one or more codewords, the codeword size, and an effective code rate associated with the one or more codewords. In some examples, the second value is equal to the first data size.

In some examples, the codeword size is associated with one or more of a fixed amount of shortening bits per codeword, a fixed amount of puncturing bits per codeword, or a fixed amount of repeated bits per codeword in accordance with the constellation shaping being applied to the set of multiple information bits.

In some examples, the encoding component 1135 is configurable or configured to obtain a quantity of parity bits per codeword in association with inputting, into an encoder associated with the error correction encoding, a set of multiple systematic bits, where the set of multiple systematic bits includes data bits and zero or more shortening bits, the data bits corresponding to the set of multiple shaped information bits; and where the effective code rate, in accordance with the fixed amount of shortening bits, the fixed amount of puncturing bits, and the fixed amount of repeated bits, is associated with a ratio between a quantity of amplitude bits and a quantity of sign bits that corresponds to one or more modulation schemes of a pattern of modulation schemes associated with the packet, the pattern of modulation schemes corresponding to an equal modulation pattern across a set of one or more spatial streams or an unequal modulation pattern across the set of one or more spatial streams.

In some examples, in association with the fixed amount of puncturing bits being non-zero, a quantity of data bits per codeword and the quantity of parity bits per codeword minus the fixed amount of puncturing bits are proportional to the quantity of amplitude bits and the quantity of sign bits, respectively, associated with a set of multiple modulation symbols associated with a data field of the packet in accordance with the effective code rate. In some examples, in association with the fixed amount of repeated bits being non-zero, the quantity of data bits per codeword and a summation of the quantity of parity bits per codeword and the fixed amount of repeated bits per codeword are proportional to the quantity of amplitude bits and the quantity of sign bits, respectively, associated with the set of multiple modulation symbols associated with the data field of the packet in accordance with the effective code rate. In some examples, in association with the fixed amount of puncturing bits being zero and in association with the fixed amount of repeated bits being zero, the quantity of data bits per codeword and the quantity of parity bits per codeword are proportional to the quantity of amplitude bits and the quantity of sign bits, respectively, associated with the set of multiple modulation symbols associated with the data field of the packet in accordance with the effective code rate.

In some examples, the effective code rate is associated with a quotient between a quantity of data bits per codeword and the codeword size. In some examples, the quantity of data bits per codeword is equal to a difference between a quantity of systematic bits per codeword and the fixed amount of shortening bits per codeword. In some examples, the quantity of systematic bits per codeword is equal to a product of a nominal codeword size and a nominal code rate associated with the error correction encoding.

In some examples, the codeword size is associated with a summation of the quantity of data bits per codeword and the quantity of parity bits per codeword minus the fixed amount of puncturing bits in association with the fixed amount of puncturing bits being non-zero. In some examples, the codeword size is associated with a summation of a quantity of data bits per codeword before repetition, the quantity of parity bits per codeword, and the fixed amount of repeated bits in association with the fixed amount of repeated bits being non-zero. In some examples, the codeword size is associated with a summation of the quantity of data bits per codeword and the quantity of parity bits per codeword in association with the fixed amount of puncturing bits being zero and in association with the fixed amount of repeated bits being zero.

In some examples, the first data size is an estimated data size associated with the set of multiple information bits after the constellation shaping. In some examples, the second data size is an actual data size associated with the set of multiple shaped information bits.

In some examples, the constellation shaping is associated with a shaping rate. In some examples, the shaping rate is associated with one or more modulation schemes of a pattern of modulation schemes, the pattern of modulation schemes corresponding to an equal modulation pattern across a set of one or more spatial streams or an unequal modulation pattern across the set of one or more spatial streams.

In some examples, the padding component 1145 is configurable or configured to add one or more additional padding bits in association with the second data size being less than the first data size, the first set of multiple padding bits including the one or more additional padding bits, and a summation of the second data size and the one or more additional padding bits being equal to the first data size. In some examples, the encoding component 1135 is configurable or configured to perform the error correction encoding in association with adding the one or more additional padding bits.

In some examples, a quantity of coded bits in a final symbol of a data field of the packet is associated with a modulo operation between a total quantity of coded bits associated with a data field of the packet and a threshold quantity of coded bits per symbol. In some examples, the total quantity of coded bits associated with the data field is associated with a product of the codeword size and the quantity of the one or more codewords.

In some examples, the quantity of the one or more codewords is associated with a floor function of a quotient between an upper limit total quantity of coded bits associated with a data field of the packet and the codeword size.

In some examples, the upper limit total quantity of coded bits is associated with a summation of a first value and a second value. In some examples, the first value is equal to a quantity of coded bits in a final symbol of the data field of the packet. In some examples, the second value is equal to a product of a third value and a fourth value. In some examples, the third value is equal to a difference between a quantity of symbols in the data field of the packet and a one value. In some examples, the fourth value is equal to a threshold quantity of coded bits per symbol.

In some examples, a quantity of symbols in a data field of the packet is associated with a lower limit total quantity of coded bits associated with the data field of the packet. In some examples, the lower limit total quantity of coded bits is associated with a product of a lower limit quantity of codewords and the codeword size. In some examples, the quantity of symbols is associated with a ceiling function of a quotient between the lower limit total quantity of coded bits and a threshold quantity of coded bits per symbol.

In some examples, the lower limit quantity of codewords is associated with a ceiling function of a quotient between the first data size and a value. In some examples, the value is equal to a product of the codeword size and an effective code rate associated with the one or more codewords. In some examples, the lower limit quantity of codewords is a smallest amount of codewords to fit the first data size.

In some examples, transmitting the packet including the one or more codewords is further in accordance with a second set of multiple padding bits associated with a post-FEC padding. In some examples, a quantity of the second set of multiple padding bits is associated with a difference between a threshold quantity of coded bits per symbol of a data field of the packet and a quantity of coded bits in a final symbol of the data field of the packet.

In some examples, the quantity of coded bits in the final symbol of the data field of the packet is associated with a product of an alpha value and a threshold quantity of coded bits per symbol segment in accordance with the alpha value being less than four. In some examples, the quantity of coded bits in the final symbol of the data field of the packet is the threshold quantity of coded bits per symbol in accordance with the alpha value being equal to four. In some examples, the alpha value is equal to a quantity of symbol segments in the final symbol. In some examples, the quantity of symbol segments in the final symbol is equal to four in accordance with a lower limit quantity of coded bits in the final symbol being equal to a zero value or is equal to a smaller of a first value and four in accordance with the lower limit quantity of coded bits in the final symbol being equal to a non-zero value. In some examples, the first value is associated with a ceiling function of a quotient between the lower limit quantity of coded bits in the final symbol and the threshold quantity of coded bits per symbol segment. In some examples, the lower limit quantity of coded bits in the final symbol is associated with a modulo operation between a lower limit total quantity of coded bits associated with the data field and the threshold quantity of coded bits per symbol.

In some examples, a nominal codeword size is equal to a largest nominal codeword size of a set of multiple available nominal codeword sizes.

In some examples, a first layer associated with the wireless communication device provides the set of multiple information bits to a second layer associated with the wireless communication device prior to an application of the constellation shaping to the set of multiple information bits. In some examples, the second layer determines the quantity of the first set of multiple padding bits subsequent to the application of the constellation shaping to the set of multiple information bits.

In some examples, a first layer associated with the wireless communication device provides the set of multiple information bits to a second layer associated with the wireless communication device prior to an application of the constellation shaping to the set of multiple information bits and provides a second set of multiple padding bits to the second layer, the second set of multiple padding bits including the first set of multiple padding bits and a third set of multiple padding bits. In some examples, the second layer stops the application of the constellation shaping at a boundary within a bit stream that includes the set of multiple information bits and the second set of multiple padding bits, the boundary separating the first set of multiple padding bits from the third set of multiple padding bits, and the boundary being a pre-forward error correction (FEC) padding boundary associated with the error correction encoding.

In some examples, a first layer associated with the wireless communication device provides the set of multiple information bits to a second layer associated with the wireless communication device prior to an application of the constellation shaping to the set of multiple information bits and provides a first subset of the first set of multiple padding bits. In some examples, the second layer determines a second subset of the first set of multiple padding bits subsequent to the application of the constellation shaping to the set of multiple information bits, the second subset of the first set of multiple padding bits including one or more first bits and one or more second bits, a summation of the one or more first bits and the second data size equaling the first data size, and a summation of the one or more second bits and the first subset of the first set of multiple padding bits provided by the first layer meeting a pre-forward error correction (FEC) padding boundary associated with the error correction encoding.

In some examples, a first layer associated with the wireless communication device provides the set of multiple information bits to a second layer associated with the wireless communication device prior to an application of the constellation shaping to the set of multiple information bits and provides a second set of multiple padding bits to the second layer, the second set of multiple padding bits including at least the first set of multiple padding bits. In some examples, the second layer performs the application of the constellation shaping and the error correction encoding until a boundary within a bit stream that includes the set of multiple information bits and the second set of multiple padding bits, the boundary associated with a threshold amount of coded bits to completely fill a last symbol of a data field of the packet.

In some examples, the first set of multiple padding bits includes unshaped bits (such as after scrambling). In some examples, the first set of multiple padding bits includes a sequence of bits selected from a shaped bit stream.

In some examples, the padding component 1145 is configurable or configured to obtain a second set of multiple padding bits associated with additional pre-FEC padding in association with receiving the second set of multiple padding bits from a first layer associated with the wireless communication device or generating the second set of multiple padding bits at a second layer associated with the wireless communication device. In some examples, the encoding component 1135 is configurable or configured to generate one or more additional codewords in accordance with the second set of multiple padding bits, where transmitting the packet is further in association with generating the one or more additional codewords.

In some examples, transmitting the packet comprising the one or more codewords is further in accordance with a second set of multiple padding bits associated with a post-FEC padding. In some examples, the second set of multiple padding bits includes a stream of random bits.

Additionally, or alternatively, the wireless communication device 1100 may support wireless communication in accordance with examples as disclosed herein. In some examples, the communication component 1140 is configurable or configured to transmit a frame that includes information associated with an application of a constellation shaping to communication between the first wireless communication device and at least a second wireless communication device. In some examples, the communication component 1140 is configurable or configured to communicate one or more packets with at least the second wireless communication device in accordance with the information associated with the application of the constellation shaping.

In some examples, to support transmitting the frame that includes the information associated with the application of the constellation shaping, the communication component 1140 is configurable or configured to transmit, via a subfield of a user info field associated with the second wireless communication device, an indication of a constellation shaping combination, from a set of multiple constellation shaping combinations, associated with the communication between the first wireless communication device and the second wireless communication device.

In some examples, the subfield is a modulation and coding scheme subfield that includes at least five bits.

In some examples, each codepoint of a first set of multiple codepoints associated with the modulation and coding scheme subfield is indicative of a respective modulation and coding scheme from a set of multiple modulation and coding schemes. In some examples, each codepoint of a second set of multiple codepoints associated with the modulation and coding scheme subfield is indicative of a respective constellation shaping combination from the set of multiple constellation shaping combinations.

In some examples, a codepoint indicated by the modulation and coding scheme subfield is from the second set of multiple codepoints. In some examples, each constellation shaping combination of the set of multiple constellation shaping combinations is associated with a respective shaping rate, a respective pattern of modulation schemes, and a respective error correction encoding rate.

In some examples, a second subfield of the user info field includes an indication of a pattern of modulation schemes associated with the communication between the first wireless communication device and at least the second wireless communication device. In some examples, the pattern of modulation schemes corresponds to an equal modulation pattern across a set of one or more spatial streams or an unequal modulation pattern across the set of one or more spatial streams. In some examples, the subfield is a modulation and coding scheme subfield that indicates that an anchor modulation and coding scheme associated with the pattern of modulation schemes is associated with the constellation shaping combination. In some examples, a combination of the anchor modulation and coding scheme and the pattern of modulation schemes indicates whether the communication between the first wireless communication device and at least the second wireless communication device is associated with constellation shaping for equal modulation or constellation shaping for unequal modulation.

In some examples, to support transmitting the frame that includes the information associated with the application of the constellation shaping, the communication component 1140 is configurable or configured to transmit an indication that the application of the constellation shaping is associated with an ON state or an OFF state.

In some examples, to support transmitting the frame that includes the information associated with the application of the constellation shaping, the communication component 1140 is configurable or configured to transmit, via a subfield of a user info field associated with the second wireless communication device, a codepoint that jointly indicates, with the indication, a constellation shaping combination, from a set of multiple constellation shaping combinations, associated with the communication between the first wireless communication device and the second wireless communication device.

In some examples, the subfield is a modulation and coding scheme subfield. In some examples, each constellation shaping combination of the set of multiple constellation shaping combinations is associated with a respective shaping rate, a respective pattern of modulation schemes, and a respective error correction encoding rate.

In some examples, a second subfield of the user info field includes an indication of a pattern of modulation schemes associated with the communication between the first wireless communication device and at least the second wireless communication device. In some examples, the pattern of modulation schemes corresponds to an equal modulation pattern across a set of one or more spatial streams or an unequal modulation pattern across the set of one or more spatial streams. In some examples, the subfield is a modulation and coding scheme subfield that indicates that an anchor modulation and coding scheme associated with the pattern of modulation schemes is associated with the constellation shaping combination. In some examples, a combination of the anchor modulation and coding scheme and the pattern of modulation schemes indicates whether the communication between the first wireless communication device and at least the second wireless communication device is associated with constellation shaping for equal modulation or constellation shaping for unequal modulation.

In some examples, a preamble of the frame includes the indication. In some examples, a common info field of the frame includes the indication. In some examples, a user info field of the frame includes the indication. In some examples, the indication consists of one bit. In some examples, communicating the one or more packets includes transmitting or receiving the one or more packets.

Additionally, or alternatively, the wireless communication device 1100 may support wireless communication in accordance with examples as disclosed herein. In some examples, the communication component 1140 is configurable or configured to receive a frame that includes information associated with an application of a constellation shaping to communication between the first wireless communication device and at least a second wireless communication device. In some examples, the communication component 1140 is configurable or configured to communicate one or more packets with at least the second wireless communication device in accordance with the information associated with the application of the constellation shaping.

In some examples, to support receiving the frame that includes the information associated with the application of the constellation shaping, the communication component 1140 is configurable or configured to receive, via a subfield of a user info field associated with the first wireless communication device, an indication of a constellation shaping combination, from a set of multiple constellation shaping combinations, associated with the communication between the first wireless communication device and the second wireless communication device.

In some examples, the subfield is a modulation and coding scheme subfield that includes at least five bits.

In some examples, each codepoint of a first set of multiple codepoints associated with the modulation and coding scheme subfield is indicative of a respective modulation and coding scheme from a set of multiple modulation and coding schemes. In some examples, each codepoint of a second set of multiple codepoints associated with the modulation and coding scheme subfield is indicative of a respective constellation shaping combination from the set of multiple constellation shaping combinations.

In some examples, a codepoint indicated by the modulation and coding scheme subfield is from the second set of multiple codepoints. In some examples, each constellation shaping combination of the set of multiple constellation shaping combinations is associated with a respective shaping rate, a respective pattern of modulation schemes, and a respective error correction encoding rate.

In some examples, a second subfield of the user info field includes an indication of a pattern of modulation schemes associated with the communication between the first wireless communication device and the second wireless communication device. In some examples, the pattern of modulation schemes corresponds to an equal modulation pattern across a set of one or more spatial streams or an unequal modulation pattern across the set of one or more spatial streams. In some examples, the subfield is a modulation and coding scheme subfield that indicates that an anchor modulation and coding scheme associated with the pattern of modulation schemes is associated with the constellation shaping combination. In some examples, a combination of the anchor modulation and coding scheme and the pattern of modulation schemes indicates whether the communication between the first wireless communication device and the second wireless communication device is associated with constellation shaping for equal modulation or constellation shaping for unequal modulation.

In some examples, to support receiving the frame that includes the information associated with the application of the constellation shaping, the communication component 1140 is configurable or configured to receive an indication that the application of the constellation shaping is associated with an ON state or an OFF state.

In some examples, to support receiving the frame that includes the information associated with the application of the constellation shaping, the communication component 1140 is configurable or configured to receive, via a subfield of a user info field associated with the first wireless communication device, a codepoint that jointly indicates, with the indication, a constellation shaping combination, from a set of multiple constellation shaping combinations, associated with the communication between the first wireless communication device and the second wireless communication device.

In some examples, the subfield is a modulation and coding scheme subfield. In some examples, each constellation shaping combination of the set of multiple constellation shaping combinations is associated with a respective shaping rate, a respective pattern of modulation schemes, and a respective error correction encoding rate.

In some examples, a second subfield of the user info field includes an indication of a pattern of modulation schemes associated with the communication between the first wireless communication device and the second wireless communication device. In some examples, the pattern of modulation schemes corresponds to an equal modulation pattern across a set of one or more spatial streams or an unequal modulation pattern across the set of one or more spatial streams. In some examples, the subfield is a modulation and coding scheme subfield that indicates that an anchor modulation and coding scheme associated with the pattern of modulation schemes is associated with the constellation shaping combination. In some examples, a combination of the anchor modulation and coding scheme and the pattern of modulation schemes indicates whether the communication between the first wireless communication device and the second wireless communication device is associated with constellation shaping for equal modulation or constellation shaping for unequal modulation.

In some examples, a preamble of the frame includes the indication. In some examples, a common info field of the frame includes the indication. In some examples, a user info field of the frame includes the indication. In some examples, the indication consists of one bit. In some examples, communicating the one or more packets includes transmitting or receiving the one or more packets.

FIG. 12 shows a flowchart illustrating an example process 1200 performable by or at a wireless communication device that supports a rate matching algorithm associated with facilitating compatibility between LDPC rate matching and probability constellation shaping. The operations of the process 1200 may be implemented by a wireless communication device or its components as described herein. For example, the process 1200 may be performed by a wireless communication device, such as the wireless communication device 1100 described with reference to FIG. 11, operating as or within a wireless AP or a wireless STA. In some examples, the process 1200 may be performed by a wireless AP or a wireless STA, such as one of the APs 102 or the STAs 104 described with reference to FIG. 1.

In some examples, in 1205, the wireless communication device may obtain information indicative of a first data size associated with a set of multiple information bits. The operations of 1205 may be performed in accordance with examples as disclosed herein. In some implementations, aspects of the operations of 1205 may be performed by a data size estimation component 1125 as described with reference to FIG. 11.

In some examples, in 1210, the wireless communication device may obtain a set of multiple shaped information bits in association with applying a constellation shaping to the set of multiple information bits, the set of multiple shaped information bits associated with a second data size different than the first data size. The operations of 1210 may be performed in accordance with examples as disclosed herein. In some implementations, aspects of the operations of 1210 may be performed by a constellation shaping component 1130 as described with reference to FIG. 11.

In some examples, in 1215, the wireless communication device may generate one or more codewords in association with performing an error correction encoding associated with the set of multiple shaped information bits and a first set of multiple padding bits, a quantity of the first set of multiple padding bits associated with at least a codeword size, a quantity of the one or more codewords, and the second data size. The operations of 1215 may be performed in accordance with examples as disclosed herein. In some implementations, aspects of the operations of 1215 may be performed by an encoding component 1135 as described with reference to FIG. 11.

In some examples, in 1220, the wireless communication device may transmit a packet including the one or more codewords in association with generating the one or more codewords. The operations of 1220 may be performed in accordance with examples as disclosed herein. In some implementations, aspects of the operations of 1220 may be performed by a communication component 1140 as described with reference to FIG. 11.

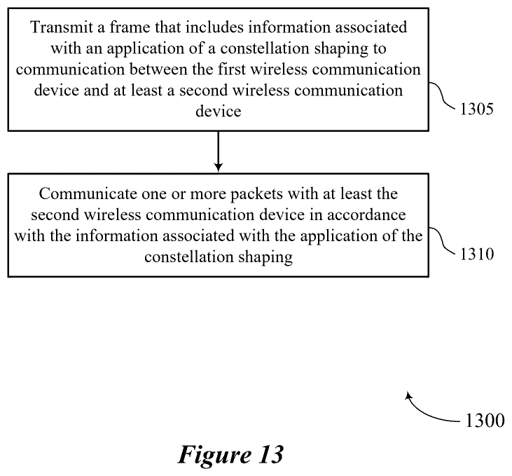

FIG. 13 shows a flowchart illustrating an example process 1300 performable by or at a first wireless communication device that supports a signaling of information associated with an application of a probability constellation shaping. The operations of the process 1300 may be implemented by a first wireless communication device or its components as described herein. For example, the process 1300 may be performed by a wireless communication device, such as the wireless communication device 1100 described with reference to FIG. 11, operating as or within a wireless A P or a wireless STA. In some examples, the process 1300 may be performed by a wireless AP or a wireless STA, such as one of the APs 102 or the STAs 104 described with reference to FIG. 1.

In some examples, in 1305, the first wireless communication device may transmit a frame that includes information associated with an application of a constellation shaping to communication between the first wireless communication device and at least a second wireless communication device. The operations of 1305 may be performed in accordance with examples as disclosed herein. In some implementations, aspects of the operations of 1305 may be performed by a communication component 1140 as described with reference to FIG. 11.

In some examples, in 1310, the first wireless communication device may communicate one or more packets with at least the second wireless communication device in accordance with the information associated with the application of the constellation shaping. The operations of 1310 may be performed in accordance with examples as disclosed herein. In some implementations, aspects of the operations of 1310 may be performed by a communication component 1140 as described with reference to FIG. 11.

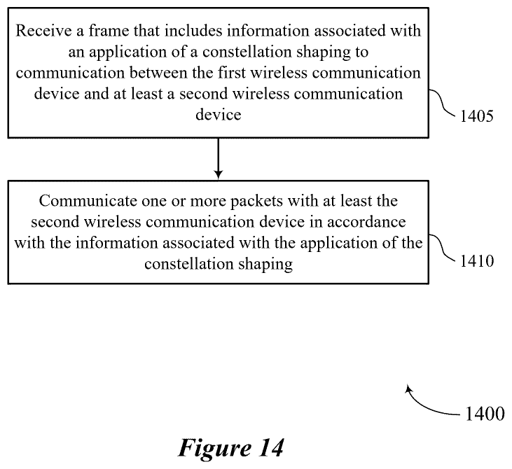

FIG. 14 shows a flowchart illustrating an example process 1400 performable by or at a first wireless communication device that supports a signaling of information associated with an application of a probability constellation shaping. The operations of the process 1400 may be implemented by a first wireless communication device or its components as described herein. For example, the process 1400 may be performed by a wireless communication device, such as the wireless communication device 1100 described with reference to FIG. 11, operating as or within a wireless A P or a wireless STA. In some examples, the process 1400 may be performed by a wireless AP or a wireless STA, such as one of the APs 102 or the STAs 104 described with reference to FIG. 1.

In some examples, in 1405, the first wireless communication device may receive a frame that includes information associated with an application of a constellation shaping to communication between the first wireless communication device and at least a second wireless communication device. The operations of 1405 may be performed in accordance with examples as disclosed herein. In some implementations, aspects of the operations of 1405 may be performed by a communication component 1140 as described with reference to FIG. 11.

In some examples, in 1410, the first wireless communication device may communicate one or more packets with at least the second wireless communication device in accordance with the information associated with the application of the constellation shaping. The operations of 1410 may be performed in accordance with examples as disclosed herein. In some implementations, aspects of the operations of 1410 may be performed by a communication component 1140 as described with reference to FIG. 11.

Implementation examples are described in the following numbered clauses:

Clause 1: A method for wireless communication at a wireless communication device, including: obtaining information indicative of a first data size associated with a plurality of information bits; obtaining a plurality of shaped information bits in association with applying a constellation shaping to the plurality of information bits, the plurality of shaped information bits associated with a second data size different than the first data size; generating one or more codewords in association with performing an error correction encoding associated with the plurality of shaped information bits and a first plurality of padding bits, a quantity of the first plurality of padding bits associated with at least a codeword size, a quantity of the one or more codewords, and the second data size; and transmitting a packet including the one or more codewords in association with generating the one or more codewords.

Clause 2: The method of clause 1, where the quantity of the first plurality of padding bits is at least associated with a difference between a first value and a second value; the first value is equal to a product of the quantity of the one or more codewords, the codeword size, and an effective code rate associated with the one or more codewords; and the second value is equal to the first data size.

Clause 3: The method of clause 2, where the codeword size is associated with one or more of a fixed amount of shortening bits per codeword, a fixed amount of puncturing bits per codeword, or a fixed amount of repeated bits per codeword in accordance with the constellation shaping being applied to the plurality of information bits.

Clause 4: The method of clause 3, further including: obtaining a quantity of parity bits per codeword in association with inputting, into an encoder associated with the error correction encoding, a plurality of systematic bits, where the plurality of systematic bits includes data bits and zero or more shortening bits, the data bits corresponding to the plurality of shaped information bits; and where the effective code rate, in accordance with the fixed amount of shortening bits, the fixed amount of puncturing bits, and the fixed amount of repeated bits, is associated with a ratio between a quantity of amplitude bits and a quantity of sign bits that corresponds to one or more modulation schemes of a pattern of modulation schemes associated with the packet, the pattern of modulation schemes corresponding to an equal modulation pattern across a set of one or more spatial streams or an unequal modulation pattern across the set of one or more spatial streams.

Clause 5: The method of clause 4, where in association with the fixed amount of puncturing bits being non-zero, a quantity of data bits per codeword and the quantity of parity bits per codeword minus the fixed amount of puncturing bits are proportional to the quantity of amplitude bits and the quantity of sign bits, respectively, associated with a plurality of modulation symbols associated with a data field of the packet in accordance with the effective code rate; in association with the fixed amount of repeated bits being non-zero, the quantity of data bits per codeword and a summation of the quantity of parity bits per codeword and the fixed amount of repeated bits per codeword are proportional to the quantity of amplitude bits and the quantity of sign bits, respectively, associated with the plurality of modulation symbols associated with the data field of the packet in accordance with the effective code rate; or in association with the fixed amount of puncturing bits being zero and in association with the fixed amount of repeated bits being zero, the quantity of data bits per codeword and the quantity of parity bits per codeword are proportional to the quantity of amplitude bits and the quantity of sign bits, respectively, associated with the plurality of modulation symbols associated with the data field of the packet in accordance with the effective code rate.

Clause 6: The method of any of clauses 4-5, where the effective code rate is associated with a quotient between a quantity of data bits per codeword and the codeword size; the quantity of data bits per codeword is equal to a difference between a quantity of systematic bits per codeword and the fixed amount of shortening bits per codeword; and the quantity of systematic bits per codeword is equal to a product of a nominal codeword size and a nominal code rate associated with the error correction encoding.

Clause 7: The method of clause 6, where the codeword size is associated with a summation of the quantity of data bits per codeword and the quantity of parity bits per codeword minus the fixed amount of puncturing bits in association with the fixed amount of puncturing bits being non-zero; the codeword size is associated with a summation of a quantity of data bits per codeword before repetition, the quantity of parity bits per codeword, and the fixed amount of repeated bits in association with the fixed amount of repeated bits being non-zero; or the codeword size is associated with a summation of the quantity of data bits per codeword and the quantity of parity bits per codeword in association with the fixed amount of puncturing bits being zero and in association with the fixed amount of repeated bits being zero.

Clause 8: The method of any of clauses 1-7, where the first data size is an estimated data size associated with the plurality of information bits after the constellation shaping; and the second data size is an actual data size associated with the plurality of shaped information bits.

Clause 9: The method of clause 8, where the constellation shaping is associated with a shaping rate; and the shaping rate is associated with one or more modulation schemes of a pattern of modulation schemes, the pattern of modulation schemes corresponding to an equal modulation pattern across a set of one or more spatial streams or an unequal modulation pattern across the set of one or more spatial streams.

Clause 10: The method of any of clauses 1-9, further including: adding one or more additional padding bits in association with the second data size being less than the first data size, the first plurality of padding bits including the one or more additional padding bits, and a summation of the second data size and the one or more additional padding bits being equal to the first data size; and performing the error correction encoding in association with adding the one or more additional padding bits.

Clause 11: The method of any of clauses 1-10, where a quantity of coded bits in a final symbol of a data field of the packet is associated with a modulo operation between a total quantity of coded bits associated with a data field of the packet and a threshold quantity of coded bits per symbol; and the total quantity of coded bits associated with the data field is associated with a product of the codeword size and the quantity of the one or more codewords.

Clause 12: The method of any of clauses 1-11, where the quantity of the one or more codewords is associated with a floor function of a quotient between an upper limit total quantity of coded bits associated with a data field of the packet and the codeword size.

Clause 13: The method of clause 12, where the upper limit total quantity of coded bits is associated with a summation of a first value and a second value; the first value is equal to a quantity of coded bits in a final symbol of the data field of the packet; the second value is equal to a product of a third value and a fourth value; the third value is equal to a difference between a quantity of symbols in the data field of the packet and a one value; and the fourth value is equal to a threshold quantity of coded bits per symbol.

Clause 14: The method of any of clauses 1-13, where a quantity of symbols in a data field of the packet is associated with a lower limit total quantity of coded bits associated with the data field of the packet; the lower limit total quantity of coded bits is associated with a product of a lower limit quantity of codewords and the codeword size; and the quantity of symbols is associated with a ceiling function of a quotient between the lower limit total quantity of coded bits and a threshold quantity of coded bits per symbol.

Clause 15: The method of clause 14, where the lower limit quantity of codewords is associated with a ceiling function of a quotient between the first data size and a value; the value is equal to a product of the codeword size and an effective code rate associated with the one or more codewords; and the lower limit quantity of codewords is a smallest amount of codewords to fit the first data size.

Clause 16: The method of any of clauses 1-15, where transmitting the packet comprising the one or more codewords is further in accordance with a second plurality of padding bits associated with a post-FEC padding, and where a quantity of the second plurality of padding bits is associated with a difference between a threshold quantity of coded bits per symbol of a data field of the packet and a quantity of coded bits in a final symbol of the data field of the packet.

Clause 17: The method of clause 16, where the quantity of coded bits in the final symbol of the data field of the packet is associated with a product of an alpha value and a threshold quantity of coded bits per symbol segment in accordance with the alpha value being less than four; the quantity of coded bits in the final symbol of the data field of the packet is the threshold quantity of coded bits per symbol in accordance with the alpha value being equal to four; the alpha value is equal to a quantity of symbol segments in the final symbol; the quantity of symbol segments in the final symbol is equal to four in accordance with a lower limit quantity of coded bits in the final symbol being equal to a zero value or is equal to a smaller of a first value and four in accordance with the lower limit quantity of coded bits in the final symbol being equal to a non-zero value; the first value is associated with a ceiling function of a quotient between the lower limit quantity of coded bits in the final symbol and the threshold quantity of coded bits per symbol segment; and the lower limit quantity of coded bits in the final symbol is associated with a modulo operation between a lower limit total quantity of coded bits associated with the data field and the threshold quantity of coded bits per symbol.

Clause 18: The method of any of clauses 1-17, where a nominal codeword size is equal to a largest nominal codeword size of a plurality of available nominal codeword sizes.

Clause 19: The method of any of clauses 1-18, where a first layer associated with the wireless communication device provides the plurality of information bits to a second layer associated with the wireless communication device prior to an application of the constellation shaping to the plurality of information bits; and the second layer determines the quantity of the first plurality of padding bits subsequent to the application of the constellation shaping to the plurality of information bits.

Clause 20: The method of any of clauses 1-19, where a first layer associated with the wireless communication device provides the plurality of information bits to a second layer associated with the wireless communication device prior to an application of the constellation shaping to the plurality of information bits and provides a second plurality of padding bits to the second layer, the second plurality of padding bits including the first plurality of padding bits and a third plurality of padding bits; and the second layer stops the application of the constellation shaping at a boundary within a bit stream that includes the plurality of information bits and the second plurality of padding bits, the boundary separating the first plurality of padding bits from the third plurality of padding bits, and the boundary being a pre-forward error correction (FEC) padding boundary associated with the error correction encoding.

Clause 21: The method of any of clauses 1-20, where a first layer associated with the wireless communication device provides the plurality of information bits to a second layer associated with the wireless communication device prior to an application of the constellation shaping to the plurality of information bits and provides a first subset of the first plurality of padding bits; and the second layer determines a second subset of the first plurality of padding bits subsequent to the application of the constellation shaping to the plurality of information bits, the second subset of the first plurality of padding bits including one or more first bits and one or more second bits, a summation of the one or more first bits and the second data size equaling the first data size, and a summation of the one or more second bits and the first subset of the first plurality of padding bits provided by the first layer meeting a pre-forward error correction (FEC) padding boundary associated with the error correction encoding.

Clause 22: The method of any of clauses 1-21, where a first layer associated with the wireless communication device provides the plurality of information bits to a second layer associated with the wireless communication device prior to an application of the constellation shaping to the plurality of information bits and provides a second plurality of padding bits to the second layer, the second plurality of padding bits including at least the first plurality of padding bits; and where the second layer performs the application of the constellation shaping and the error correction encoding until a boundary within a bit stream that includes the plurality of information bits and the second plurality of padding bits, the boundary associated with a threshold amount of coded bits to completely fill a last symbol of a data field of the packet.

Clause 23: The method of any of clauses 1-22, where the first plurality of padding bits includes unshaped bits; or the first plurality of padding bits includes a sequence of bits selected from a shaped bit stream.

Clause 24: The method of any of clauses 1-23, further including: obtaining a second plurality of padding bits associated with additional pre-FEC padding in association with receiving the second plurality of padding bits from a first layer associated with the wireless communication device or generating the second plurality of padding bits at a second layer associated with the wireless communication device; and generating one or more additional codewords in accordance with the second plurality of padding bits, where transmitting the packet is further in association with generating the one or more additional codewords.

Clause 25: The method of any of clauses 1-24, where transmitting the packet comprising the one or more codewords is further in accordance with a second plurality of padding bits associated with a post-FEC padding, and where the second plurality of padding bits includes a stream of random bits.

Clause 26: A method for wireless communication at a first wireless communication device, including: transmitting a frame that includes information associated with an application of a constellation shaping to communication between the first wireless communication device and at least a second wireless communication device; and communicating one or more packets with at least the second wireless communication device in accordance with the information associated with the application of the constellation shaping.

Clause 27: The method of clause 26, where transmitting the frame that includes the information associated with the application of the constellation shaping includes: transmitting, via a subfield of a user info field associated with the second wireless communication device, an indication of a constellation shaping combination, from a plurality of constellation shaping combinations, associated with the communication between the first wireless communication device and the second wireless communication device.

Clause 28: The method of clause 27, where the subfield is a modulation and coding scheme subfield that includes at least five bits.

Clause 29: The method of clause 28, where each codepoint of a first plurality of codepoints associated with the modulation and coding scheme subfield is indicative of a respective modulation and coding scheme from a plurality of modulation and coding schemes; and each codepoint of a second plurality of codepoints associated with the modulation and coding scheme subfield is indicative of a respective constellation shaping combination from the plurality of constellation shaping combinations.

Clause 30: The method of clause 29, where a codepoint indicated by the modulation and coding scheme subfield is from the second plurality of codepoints.

Clause 31: The method of any of clauses 27-30, where each constellation shaping combination of the plurality of constellation shaping combinations is associated with a respective shaping rate, a respective pattern of modulation schemes, and a respective error correction encoding rate.

Clause 32: The method of any of clauses 27-31, where a second subfield of the user info field includes an indication of a pattern of modulation schemes associated with the communication between the first wireless communication device and at least the second wireless communication device; the pattern of modulation schemes corresponds to an equal modulation pattern across a set of one or more spatial streams or an unequal modulation pattern across the set of one or more spatial streams; and the subfield is a modulation and coding scheme subfield that indicates that an anchor modulation and coding scheme associated with the pattern of modulation schemes is associated with the constellation shaping combination.

Clause 33: The method of clause 32, where a combination of the anchor modulation and coding scheme and the pattern of modulation schemes indicates whether the communication between the first wireless communication device and at least the second wireless communication device is associated with constellation shaping for equal modulation or constellation shaping for unequal modulation.

Clause 34: The method of any of clauses 26-33, where transmitting the frame that includes the information associated with the application of the constellation shaping includes: transmitting an indication that the application of the constellation shaping is associated with an ON state or an OFF state.

Clause 35: The method of clause 34, where transmitting the frame that includes the information associated with the application of the constellation shaping further includes: transmitting, via a subfield of a user info field associated with the second wireless communication device, a codepoint that jointly indicates, with the indication, a constellation shaping combination, from a plurality of constellation shaping combinations, associated with the communication between the first wireless communication device and the second wireless communication device.

Clause 36: The method of clause 35, where the subfield is a modulation and coding scheme subfield.

Clause 37: The method of any of clauses 35-36, where each constellation shaping combination of the plurality of constellation shaping combinations is associated with a respective shaping rate, a respective pattern of modulation schemes, and a respective error correction encoding rate.

Clause 38: The method of any of clauses 35-37, where a second subfield of the user info field includes an indication of a pattern of modulation schemes associated with the communication between the first wireless communication device and at least the second wireless communication device; the pattern of modulation schemes corresponds to an equal modulation pattern across a set of one or more spatial streams or an unequal modulation pattern across the set of one or more spatial streams; and the subfield is a modulation and coding scheme subfield that indicates that an anchor modulation and coding scheme associated with the pattern of modulation schemes is associated with the constellation shaping combination.

Clause 39: The method of clause 38, where a combination of the anchor modulation and coding scheme and the pattern of modulation schemes indicates whether the communication between the first wireless communication device and at least the second wireless communication device is associated with constellation shaping for equal modulation or constellation shaping for unequal modulation.

Clause 40: The method of any of clauses 34-39, where a preamble of the frame includes the indication.

Clause 41: The method of any of clauses 34-40, where a common info field of the frame includes the indication.

Clause 42: The method of any of clauses 34-41, where a user info field of the frame includes the indication.

Clause 43: The method of any of clauses 34-42, where the indication consists of one bit.

Clause 44: The method of any of clauses 26-43, where communicating the one or more packets includes transmitting or receiving the one or more packets.

Clause 45: A method for wireless communication at a first wireless communication device, including: receiving a frame that includes information associated with an application of a constellation shaping to communication between the first wireless communication device and at least a second wireless communication device; and communicating one or more packets with at least the second wireless communication device in accordance with the information associated with the application of the constellation shaping.

Clause 46: The method of clause 45, where receiving the frame that includes the information associated with the application of the constellation shaping includes: receiving, via a subfield of a user info field associated with the first wireless communication device, an indication of a constellation shaping combination, from a plurality of constellation shaping combinations, associated with the communication between the first wireless communication device and the second wireless communication device.

Clause 47: The method of clause 46, where the subfield is a modulation and coding scheme subfield that includes at least five bits.

Clause 48: The method of clause 47, where each codepoint of a first plurality of codepoints associated with the modulation and coding scheme subfield is indicative of a respective modulation and coding scheme from a plurality of modulation and coding schemes; and each codepoint of a second plurality of codepoints associated with the modulation and coding scheme subfield is indicative of a respective constellation shaping combination from the plurality of constellation shaping combinations.

Clause 49: The method of clause 48, where a codepoint indicated by the modulation and coding scheme subfield is from the second plurality of codepoints.

Clause 50: The method of any of clauses 46-49, where each constellation shaping combination of the plurality of constellation shaping combinations is associated with a respective shaping rate, a respective pattern of modulation schemes, and a respective error correction encoding rate.

Clause 51: The method of any of clauses 46-50, where a second subfield of the user info field includes an indication of a pattern of modulation schemes associated with the communication between the first wireless communication device and the second wireless communication device; the pattern of modulation schemes corresponds to an equal modulation pattern across a set of one or more spatial streams or an unequal modulation pattern across the set of one or more spatial streams; and the subfield is a modulation and coding scheme subfield that indicates that an anchor modulation and coding scheme associated with the pattern of modulation schemes is associated with the constellation shaping combination.

Clause 52: The method of clause 51, where a combination of the anchor modulation and coding scheme and the pattern of modulation schemes indicates whether the communication between the first wireless communication device and the second wireless communication device is associated with constellation shaping for equal modulation or constellation shaping for unequal modulation.

Clause 53: The method of any of clauses 45-52, where receiving the frame that includes the information associated with the application of the constellation shaping includes: receiving an indication that the application of the constellation shaping is associated with an ON state or an OFF state.

Clause 54: The method of clause 53, where receiving the frame that includes the information associated with the application of the constellation shaping further includes: receiving, via a subfield of a user info field associated with the first wireless communication device, a codepoint that jointly indicates, with the indication, a constellation shaping combination, from a plurality of constellation shaping combinations, associated with the communication between the first wireless communication device and the second wireless communication device.

Clause 55: The method of clause 54, where the subfield is a modulation and coding scheme subfield.

Clause 56: The method of any of clauses 54-55, where each constellation shaping combination of the plurality of constellation shaping combinations is associated with a respective shaping rate, a respective pattern of modulation schemes, and a respective error correction encoding rate.

Clause 57: The method of any of clauses 54-56, where a second subfield of the user info field includes an indication of a pattern of modulation schemes associated with the communication between the first wireless communication device and the second wireless communication device; the pattern of modulation schemes corresponds to an equal modulation pattern across a set of one or more spatial streams or an unequal modulation pattern across the set of one or more spatial streams; and the subfield is a modulation and coding scheme subfield that indicates that an anchor modulation and coding scheme associated with the pattern of modulation schemes is associated with the constellation shaping combination.

Clause 58: The method of clause 57, where a combination of the anchor modulation and coding scheme and the pattern of modulation schemes indicates whether the communication between the first wireless communication device and the second wireless communication device is associated with constellation shaping for equal modulation or constellation shaping for unequal modulation.

Clause 59: The method of any of clauses 53-58, where a preamble of the frame includes the indication.

Clause 60: The method of any of clauses 53-59, where a common info field of the frame includes the indication.

Clause 61: The method of any of clauses 53-60, where a user info field of the frame includes the indication.

Clause 62: The method of any of clauses 53-61, where the indication consists of one bit.

Clause 63: The method of any of clauses 45-62, where communicating the one or more packets includes transmitting or receiving the one or more packets.

Clause 64: An apparatus for wireless communication at a wireless communication device, including a processing system that includes processor circuitry and memory circuitry that stores code, the processing system configured to cause the apparatus to perform a method of any of clauses 1-25.

Clause 65: An apparatus for wireless communication at a wireless communication device, including one or more memories storing processor-executable code, and one or more processors coupled with the one or more memories and individually or collectively operable to execute the code to cause the apparatus to perform a method of any of clauses 1-25.

Clause 66: An apparatus for wireless communication at a wireless communication device, including at least one means for performing a method of any of clauses 1-25.

Clause 67: A non-transitory computer-readable medium storing code for wireless communication, the code including instructions executable by one or more processors to perform a method of any of clauses 1-25.

Clause 68: An apparatus for wireless communication at a first wireless communication device, including a processing system that includes processor circuitry and memory circuitry that stores code, the processing system configured to cause the apparatus to perform a method of any of clauses 26-44.

Clause 69: An apparatus for wireless communication at a first wireless communication device, including one or more memories storing processor-executable code, and one or more processors coupled with the one or more memories and individually or collectively operable to execute the code to cause the apparatus to perform a method of any of clauses 26-44.

Clause 70: An apparatus for wireless communication at a first wireless communication device, including at least one means for performing a method of any of clauses 26-44.

Clause 71: A non-transitory computer-readable medium storing code for wireless communication, the code including instructions executable by one or more processors to perform a method of any of clauses 26-44.

Clause 72: An apparatus for wireless communication at a first wireless communication device, including a processing system that includes processor circuitry and memory circuitry that stores code, the processing system configured to cause the apparatus to perform a method of any of clauses 45-63.

Clause 73: An apparatus for wireless communication at a first wireless communication device, including one or more memories storing processor-executable code, and one or more processors coupled with the one or more memories and individually or collectively operable to execute the code to cause the apparatus to perform a method of any of clauses 45-63.

Clause 74: An apparatus for wireless communication at a first wireless communication device, including at least one means for performing a method of any of clauses 45-63.

Clause 75: A non-transitory computer-readable medium storing code for wireless communication, the code including instructions executable by one or more processors to perform a method of any of clauses 45-63.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions. Further, “obtaining” can include receiving (via wireless or wired communication, including at one entity or layer from another entity or layer), retrieving (from one or more memories), identifying, selecting, determining, calculating, or estimating, among other possibilities.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. An apparatus for wireless communication at a wireless communication device, comprising:
a processing system that includes processor circuitry and memory circuitry that stores code, the processing system configured to cause the apparatus to:
obtain information indicative of a first data size associated with a plurality of information bits;
obtain a plurality of shaped information bits in association with applying a constellation shaping to the plurality of information bits, the plurality of shaped information bits associated with a second data size different than the first data size;
generate one or more codewords in association with performing an error correction encoding associated with the plurality of shaped information bits and a first plurality of padding bits, a quantity of the first plurality of padding bits associated with at least a codeword size, a quantity of the one or more codewords, and the second data size; and
transmit a packet comprising the one or more codewords in association with generating the one or more codewords.

2. The apparatus of claim 1, wherein:
the quantity of the first plurality of padding bits is at least associated with a difference between a first value and a second value;
the first value is equal to a product of the quantity of the one or more codewords, the codeword size, and an effective code rate associated with the one or more codewords; and
the second value is equal to the first data size.

3. The apparatus of claim 2, wherein the codeword size is associated with one or more of a fixed amount of shortening bits per codeword, a fixed amount of puncturing bits per codeword, or a fixed amount of repeated bits per codeword in accordance with the constellation shaping being applied to the plurality of information bits.

4. The apparatus of claim 3, wherein the processing system is further configured to cause the apparatus to:
obtain a quantity of parity bits per codeword in association with inputting, into an encoder associated with the error correction encoding, a plurality of systematic bits, wherein:
the plurality of systematic bits includes data bits and zero or more shortening bits, the data bits corresponding to the plurality of shaped information bits;
the effective code rate, in accordance with the fixed amount of shortening bits, the fixed amount of puncturing bits, and the fixed amount of repeated bits, is associated with a ratio between a quantity of amplitude bits and a quantity of sign bits that corresponds to one or more modulation schemes of a pattern of modulation schemes associated with the packet, the pattern of modulation schemes corresponding to an equal modulation pattern across a set of one or more spatial streams or an unequal modulation pattern across the set of one or more spatial streams;
the effective code rate is further associated with a quotient between a quantity of data bits per codeword and the codeword size;
the quantity of data bits per codeword is equal to a difference between a quantity of systematic bits per codeword and the fixed amount of shortening bits per codeword; and
the quantity of systematic bits per codeword is equal to a product of a nominal codeword size and a nominal code rate associated with the error correction encoding.

5. The apparatus of claim 4, wherein:
in association with the fixed amount of puncturing bits being non-zero, the quantity of data bits per codeword and the quantity of parity bits per codeword minus the fixed amount of puncturing bits are proportional to the quantity of amplitude bits and the quantity of sign bits, respectively, associated with a plurality of modulation symbols associated with a data field of the packet in accordance with the effective code rate;
in association with the fixed amount of repeated bits being non-zero, the quantity of data bits per codeword and a summation of the quantity of parity bits per codeword and the fixed amount of repeated bits per codeword are proportional to the quantity of amplitude bits and the quantity of sign bits, respectively, associated with the plurality of modulation symbols associated with the data field of the packet in accordance with the effective code rate; or
in association with the fixed amount of puncturing bits being zero and in association with the fixed amount of repeated bits being zero, the quantity of data bits per codeword and the quantity of parity bits per codeword are proportional to the quantity of amplitude bits and the quantity of sign bits, respectively, associated with the plurality of modulation symbols associated with the data field of the packet in accordance with the effective code rate.

6. (canceled)

7. The apparatus of claim 4, wherein:
the codeword size is associated with a summation of the quantity of data bits per codeword and the quantity of parity bits per codeword minus the fixed amount of puncturing bits in association with the fixed amount of puncturing bits being non-zero;
the codeword size is associated with a summation of a quantity of data bits per codeword before repetition, the quantity of parity bits per codeword, and the fixed amount of repeated bits in association with the fixed amount of repeated bits being non-zero; or
the codeword size is associated with a summation of the quantity of data bits per codeword and the quantity of parity bits per codeword in association with the fixed amount of puncturing bits being zero and in association with the fixed amount of repeated bits being zero.

8. The apparatus of claim 1, wherein:
the first data size is an estimated data size associated with the plurality of information bits after the constellation shaping; and
the second data size is an actual data size associated with the plurality of shaped information bits.

9. The apparatus of claim 8, wherein:
the constellation shaping is associated with a shaping rate; and
the shaping rate is associated with one or more modulation schemes of a pattern of modulation schemes, the pattern of modulation schemes corresponding to an equal modulation pattern across a set of one or more spatial streams or an unequal modulation pattern across the set of one or more spatial streams.

10. The apparatus of claim 1, wherein the processing system is further configured to cause the apparatus to:
add one or more additional padding bits in association with the second data size being less than the first data size, the first plurality of padding bits including the one or more additional padding bits, and a summation of the second data size and the one or more additional padding bits being equal to the first data size; and
perform the error correction encoding in association with adding the one or more additional padding bits.

11. The apparatus of claim 1, wherein:
a quantity of coded bits in a final symbol of a data field of the packet is associated with a modulo operation between a total quantity of coded bits associated with a data field of the packet and a threshold quantity of coded bits per symbol; and
the total quantity of coded bits associated with the data field is associated with a product of the codeword size and the quantity of the one or more codewords.

12. The apparatus of claim 1, wherein the quantity of the one or more codewords is associated with a floor function of a quotient between an upper limit total quantity of coded bits associated with a data field of the packet and the codeword size.

13. (canceled)

14. The apparatus of claim 1, wherein:
a quantity of symbols in a data field of the packet is associated with a lower limit total quantity of coded bits associated with the data field of the packet;
the lower limit total quantity of coded bits is associated with a product of a lower limit quantity of codewords and the codeword size;
the lower limit quantity of codewords is associated with a ceiling function of a quotient between the first data size and a value;
the value is equal to a product of the codeword size and an effective code rate associated with the one or more codewords;
the lower limit quantity of codewords is a smallest amount of codewords to fit the first data size; and
the quantity of symbols is associated with a ceiling function of a quotient between the lower limit total quantity of coded bits and a threshold quantity of coded bits per symbol.

15. (canceled)

16. (canceled)

17. The apparatus of claim 1, wherein:
transmission of the packet comprising the one or more codewords is further in accordance with a second plurality of padding bits associated with a post-forward error correction (FEC) padding;
a quantity of the second plurality of padding bits is associated with a difference between a threshold quantity of coded bits per symbol of a data field of the packet and a quantity of coded bits in a final symbol of the data field of the packet;
the quantity of coded bits in the final symbol of the data field of the packet is associated with a product of an alpha value and a threshold quantity of coded bits per symbol segment in accordance with the alpha value being less than four;
the quantity of coded bits in the final symbol of the data field of the packet is the threshold quantity of coded bits per symbol in accordance with the alpha value being equal to four;
the alpha value is equal to a quantity of symbol segments in the final symbol;
the quantity of symbol segments in the final symbol is equal to four in accordance with a lower limit quantity of coded bits in the final symbol being equal to a zero value or is equal to a smaller of a first value and four in accordance with the lower limit quantity of coded bits in the final symbol being equal to a non-zero value;
the first value is associated with a ceiling function of a quotient between the lower limit quantity of coded bits in the final symbol and the threshold quantity of coded bits per symbol segment; and
the lower limit quantity of coded bits in the final symbol is associated with a modulo operation between a lower limit total quantity of coded bits associated with the data field and the threshold quantity of coded bits per symbol.

18. (canceled)

19. The apparatus of claim 1, wherein:
a first layer associated with the wireless communication device provides the plurality of information bits to a second layer associated with the wireless communication device prior to an application of the constellation shaping to the plurality of information bits; and
the second layer determines the quantity of the first plurality of padding bits subsequent to the application of the constellation shaping to the plurality of information bits.

20. The apparatus of claim 1, wherein:
a first layer associated with the wireless communication device provides the plurality of information bits to a second layer associated with the wireless communication device prior to an application of the constellation shaping to the plurality of information bits and provides a second plurality of padding bits to the second layer, the second plurality of padding bits including at least the first plurality of padding bits and a third plurality of padding bits; and
the second layer stops the application of the constellation shaping at a boundary within a bit stream that includes the plurality of information bits and the second plurality of padding bits, the boundary separating the first plurality of padding bits from the third plurality of padding bits, and the boundary being a pre-forward error correction (FEC) padding boundary associated with the error correction encoding.

21. The apparatus of claim 1, wherein:
a first layer associated with the wireless communication device provides the plurality of information bits to a second layer associated with the wireless communication device prior to an application of the constellation shaping to the plurality of information bits and provides a first subset of the first plurality of padding bits; and
the second layer determines a second subset of the first plurality of padding bits subsequent to the application of the constellation shaping to the plurality of information bits, the second subset of the first plurality of padding bits including one or more first bits and one or more second bits, a summation of the one or more first bits and the second data size equaling the first data size, and a summation of the one or more second bits and the first subset of the first plurality of padding bits provided by the first layer meeting a pre-forward error correction (FEC) padding boundary associated with the error correction encoding.

22. The apparatus of claim 1, wherein:
a first layer associated with the wireless communication device provides the plurality of information bits to a second layer associated with the wireless communication device prior to an application of the constellation shaping to the plurality of information bits and provides a second plurality of padding bits to the second layer, the second plurality of padding bits including at least the first plurality of padding bits; and
the second layer performs the application of the constellation shaping and the error correction encoding until a boundary within a bit stream that includes the plurality of information bits and the second plurality of padding bits, the boundary associated with a threshold amount of coded bits to completely fill a last symbol of a data field of the packet.

23. The apparatus of claim 1, wherein:
the first plurality of padding bits comprises unshaped bits; or
the first plurality of padding bits comprises a sequence of bits selected from a shaped bit stream.

24. The apparatus of claim 1, wherein the processing system is further configured to cause the wireless communication device to:
obtain a second plurality of padding bits associated with additional pre-forward error correction (FEC) padding in association with receiving the second plurality of padding bits from a first layer associated with the wireless communication device or generating the second plurality of padding bits at a second layer associated with the wireless communication device; and
generate one or more additional codewords in accordance with the second plurality of padding bits, wherein transmitting the packet is further in association with generating the one or more additional codewords.

25-53. (canceled)

54. A method for wireless communication at a wireless communication device, comprising:
obtaining information indicative of a first data size associated with a plurality of information bits;
obtaining a plurality of shaped information bits in association with applying a constellation shaping to the plurality of information bits, the plurality of shaped information bits associated with a second data size different than the first data size;
generating one or more codewords in association with performing an error correction encoding associated with the plurality of shaped information bits and a first plurality of padding bits, a quantity of the first plurality of padding bits associated with at least a codeword size, a quantity of the one or more codewords, and the second data size; and
transmitting a packet comprising the one or more codewords in association with generating the one or more codewords.

55-106. (canceled)
